(19) United States
(12) Patent Application Publication
(10) Pub. No.: US 2024/0294685 A1
(43) Pub. Date: Sep. 5, 2024

(54) ELECTROCHEMICALLY-REGENERATED ION EXCHANGE USING REDOX-POLYMERS

(71) Applicant: THE BOARD OF TRUSTEES OF THE UNIVERSITY OF ILLINOIS, Urbana, IL (US)

(72) Inventors: Xiao SU, Champaign, IL (US); Haley VAPNIK, Tarzana, CA (US); Johannes ELBERT, Urbana, IL (US)

(73) Assignee: THE BOARD OF TRUSTEES OF THE UNIVERSITY OF ILLINOIS, Urbana, IL (US)

(21) Appl. No.: 18/568,609

(22) PCT Filed: Jun. 9, 2022
(86) PCT No.: PCT/US2022/032852

§ 371 Date: Dec. 8, 2023

Related U.S. Application Data
(60) Provisional application No. 63/209,104, filed on Jun. 10, 2021.

(51) Int. Cl. C08F 230/04; B01D 15/20; B01D 15/36; C02F 1/42; C02F 101/20; C09D 143/00

(52) U.S. Cl. CPC C08F 230/04; B01D 15/203; B01D 15/362; C02F 1/42; C09D 143/00; C02F 2001/425; C02F 2101/20; C02F 2303/16

(57) ABSTRACT

Rare earth elements (REEs) play an essential role in our modern society, being critical resources for the growing electronic devices and renewable energy technologies. For the reversible capture and release of REEs, we designed and synthesized a redox-copolymer poly(ferrocenylpropyl methacrylamide-co-methacrylic acid) (P(FPMAm-co-MAA)) that combines an ion-exchange carboxylic acid group for REE adsorption, and an redox-active ferrocene moiety for electrochemical regeneration. By molecularly tuning the copolymer composition, efficient adsorption uptake could be achieved alongside electrochemically regenerated adsorbent reuse. The copolymer sorbent showed stoichiometric binding for yttrium (Y), cerium (Ce), neodymium (Nd), europium (Eu), gadolinium (Gd), and dysprosium (Dy) based on carboxylic acid active site.

### RELATED APPLICATIONS

This application claims priority under 35 U.S.C. § 119(e) to U.S. Provisional Patent Application No. 63/209,104, filed Jun. 10, 2021, which is incorporated herein by reference.

### GOVERNMENT SUPPORT

This invention was made with government support under Grant No. DE-SC0021409 awarded by the U.S. Department of Energy. The government has certain rights in the invention.

### BACKGROUND OF THE INVENTION

Rare earth elements (REEs) are a group of 17 chemically similar elements consisting of 15 lanthanides plus Scandium (Sc) and Yttrium (Y). The unique magnetic, phosphorescent, and catalytic properties of REEs make them irreplaceable components in a growing technology market. They play a key role in many products, from computers and smartphones to rechargeable batteries, lasers, and electric automobiles. Over the past decades, the consumption of REEs has steadily increased due to their uses in new materials and renewable technologies. The world production of REEs has been geographically limited, with many countries mostly relying on imported REEs from limited supply sources.

Commonly used methods for REE separation include chemical precipitation, liquid-liquid extraction, ion-exchange, and adsorption. However, many of these conventional approaches produce significant hazardous waste, require chemical addition, and often have challenges in molecular selectivity. Adsorption can provide a powerful platform for molecular selectivity, due to the library of specific groups which have proven affinity with REEs, including carboxyl and hydroxyl groups. However, adsorption often requires significant chemical consumption during regeneration of adsorbent materials, including addition of acids and bases.

Electrochemical separations offer a green alternative for REE recovery, allowing for a chemical-free regeneration step fully promoted by electron-transfer. Electrosorption-based techniques, for ion recovery, can eliminate the need of regeneration chemicals needed with current adsorption methods. Redox-active materials in particular have been shown to promote selective molecular binding. Redox-active polymers containing ferrocenyl groups have shown high selectivity towards anionic contaminants, including arsenic and transition metal oxyanions. However, these redox-polymer platforms have mostly been limited to anion separation, with little attention devoted to cation-selective separations. These limitations are partly due to a lack of redox-active polymers being able to sustain a negative charge in aqueous solutions at neutral or acidic pH values.

Recently, redox-copolymers have been used to modulate hydrophobicity and electrostatic interactions orthogonally for PFAS electrosorption, by leveraging binding groups for PFAS with redox-active TEMPO groups for hydrophobicity and electrostatic control. Unlike homopolymers, copolymers can combine different functionalities from distinct monomer units to leverage synergistic effects.

Both the European Commission as well as the U.S. Department of Energy (DOE) consider REEs to have critical supply risk, especially for neodymium (Nd), europium (Eu), terbium (Tb), dysprosium (Dy), and yttrium (Y). With increasing demand, restricted supply, and low recycling rate, there is an urgent need for efficient REE recovery technologies. Thus, there is a significant demand for functional polymer design concepts for cation-selective systems, especially for REE and other critical element recovery.

### SUMMARY

Rare earth elements (REEs) play an essential role in our modern society, being critical resources for the growing electronic devices and renewable energy technologies. Efficient technologies for REE recovery and purification are essential to resource security and environmental management. Imparting electrochemical control over an adsorbent system can lead to higher modularity and sustainability, by enabling chemical-free adsorbent regeneration. Our general concept comprises in the copolymerization of a (a) redox-group, with electrochemically-modulated properties and potential/current-tunable electrostatics for adsorption/release, and a (b) chemical binding chelator or ion-exchange group for selectivity towards the REEs. To demonstrate this principle for the reversible capture and release of REEs, we design and synthesize a redox-copolymer poly(ferrocenylpropyl methacrylamide-co-methacrylic acid) (P(FPMAm-co-MAA)) that combines an ion-exchange carboxylic acid group for REE adsorption, and an redox-active ferrocene moiety for electrochemical regeneration. By molecularly tuning the copolymer composition, efficient adsorption uptake could be achieved alongside electrochemically-regenerated adsorbent reuse. The copolymer electrodes exhibited a Y(III) adsorption capacity of 69.4 mg Y/(g polymer), and electrochemical regeneration close to 100% efficiency through oxidation of the ferrocenium units. The copolymer sorbent showed stoichiometric binding for yttrium (Y), cerium (Ce), neodymium (Nd), europium (Eu), gadolinium (Gd), and dysprosium (Dy) based on carboxylic acid active site. Our work provides a proof-of-concept for electrochemically-regenerable ion-exchange copolymers for REE recovery, and we envision generalized applications of this concept for electrifying ion-exchange systems and cation-selective separations, including water softening systems for removal of alkaline earth (Group 2A) metals.

Accordingly, this disclosure provides a redox-active copolymer comprising:
a) a first monomer comprising a redox group, wherein the redox-group comprises a redox-active transition metal or an organic redox-moiety, and
b) a second monomer comprising a chemical binding group that can bind a rare earth element (REE) transition metal ion or an alkaline earth metal ion, wherein the chemical binding group is an organic acid, a chelator, or an organic ligand; wherein the first monomer and second monomer form the redox-active copolymer.

In some embodiments, the redox-active copolymer comprises:
a) a monomer comprising a redox group, wherein the redox-group can contain a redox-active transition metal or organic redox-moiety, and
b) a monomer comprising a chemical binding group to transition metals or ions (e.g., REEs) or alkaline earth metals or ions, wherein the chemical binding group could be an organic acid, a transition metal chelator, or organic ligands for REEs; wherein the a) monomer and b) monomer form the redox-active copolymer.

In some embodiments the copolymer is represented by Formula I, II or III:

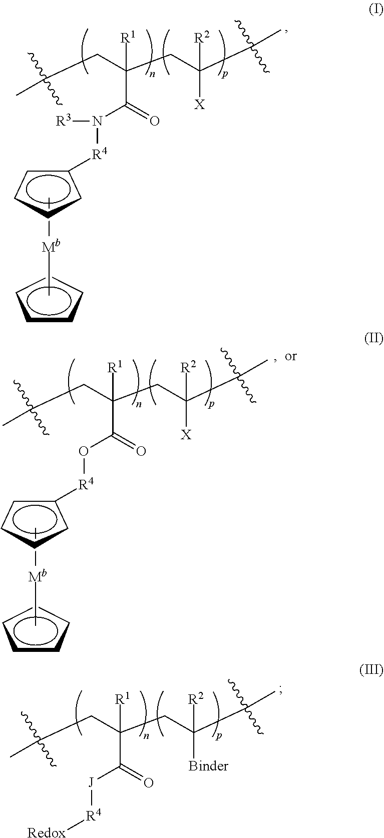

wherein
M is a transition metal;
b is the oxidation state of M wherein the oxidation state is 0-6;
R¹ and R² are each independently —(C₁-C₆)alkyl, —(C₁-C₆)cycloalkyl, or H;
R³ is H, —(C₁-C₆)alkyl, or —(C₁-C₆)cycloalkyl;
R⁴ is —(C₁-C₁₀)alkylene-;
Redox is an organic moiety comprising an aminoxyl group;
X or Binder are C(═O)OH, P(═O)(OH)₂, S(═O)₂OH, or a metal ion chelating group;
n is 1-10,000; and
p is 1-10,000;
   wherein the metallocene moiety is optionally further substituted.

This disclosure also provides an electrode comprising a composition of a copolymer disclosed herein and a carbon nanotube wherein the composition is coated on a conductor of the electrode.

Additionally, this disclosure provides a method for separating or removing an element from a mixture comprising:
a) adsorbing a metal ion of an element on an electrode disclosed herein under suitable adsorption conditions to separate the metal ion from the mixture, wherein the redox group of the electrode has a net charge of zero; and
b) electrochemically desorbing the metal ion from the electrode into an electrolyte under suitable desorption conditions, wherein the redox group of the electrode has been oxidized to a net charge of at least +1.

The invention provides novel copolymers of Formula I, II, or III, intermediates for the synthesis of copolymers of Formula I, II or III, as well as methods of preparing copolymers of Formula I, II or III. The invention also provides copolymers of Formula I, II or III that are useful as intermediates for the synthesis of other useful copolymers. The invention provides for the use of copolymers of Formula I, II or III for the manufacture of metal ion separation or removal devices useful for the separation or removal of rare earth metal ions or Group IIA metal ions from mixtures such as brackish water, industrial wastewater, or hard water.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. Overview of the reversible capture and release of REEs by P(FPMAm-co-MAA) through electrochemically regenerated ion exchange. During adsorption, REE ions are captured by chemical ion exchange. During desorption, ferrocene (Fc) is oxidized to ferrocenium (Fc⁺) electrochemically, allowing for desorption of the REE ions through electrostatic repulsion. Reduction of ferrocenium (Fc⁺) back to ferrocene (Fc) is required for electrode cycling.

FIG. 2. The removal of REE ions. All run conditions are as follows: 1 h, open circuit, 10 mL aqueous solution with 1 mM RE(Cl)₃ and 20 mM NaCl. a) Uptake of Y(III) onto polymer-CNT/Ti electrodes, with copolymers of various ratios of ferrocenyl groups to carboxylic acid groups. b) Number of Y(III) adsorbed to number of available adsorption sites (carboxylic acid sites) onto polymer-CNT (P1-CNT) electrodes with polymers having various ratios of ferrocenyl groups to carboxylic acid groups. c) Uptake of various REEs using P1-CNT. d) Ratio of RE(III) adsorbed to available adsorption sites based on carboxylic units in the polymer.

FIG. 3. (a) Effect of pH on Y(III) adsorption uptake on P1-CNT. (b) Kinetic data and pseudo first-order model for the adsorption. (c) Adsorption isotherm and Langmuir fit line of Y(III) adsorption on P1-CNT.

FIG. 4. The regeneration efficiency of REE ions. All adsorption prior to regeneration was conducted using standard adsorption parameters listed earlier (1 h, open circuit, 10 mL aqueous solution with 1 mM RE(Cl)₃ and 20 mM NaCl). All desorption conditions are as follows: 1 h, 10 mL aqueous solution with 20 mM NaCl. a) Desorption of Y(III) from loaded P1-CNT electrodes at various applied potentials. b) Adsorption/Desorption of Y(III) with polymer-CNT electrodes with polymers having various ratios of ferrocenyl groups to carboxyl groups. Desorption with applied potential of +0.8 V Ag/AgCl. c) REE uptake/regeneration efficiency using P1-CNT. d) XPS surface analysis of P1-CNT before REE adsorption (blank), after Y(III) adsorption (Ads), and after Y(III) adsorption/desorption (Des).

FIG. 5. High resolution Fe2p spectra of the surface of P1-CNT at different stages of the adsorption/desorption process. a) Pristine (Blank) P1-CNT. b) P1-CNT used for adsorption of Y(III) for 1 h, open circuit, 10 mL aqueous solution with 1 mM YCl₃ and 20 mM NaCl. c) P1-CNT after adsorption of Y(III) regenerated (desorbed) for 1 h in 10 mL aqueous solution containing 20 mM NaCl with applied potential of +0.8 V Ag/AgCl. d) Adsorption-desorption cycling runs using P1-CNT with adsorption of Y(III) for 1 h, open circuit, 10 mL aqueous solution with 1 mM YCl₃ and 20 mM NaCl and desorption for 1 h in 10 mL aqueous solution containing 20 mM NaCl with applied potential of +0.8 V Ag/AgCl.

FIG. 6. Elugram of the size-exclusion-chromatography of P(FPMAm₆₉-co-MAA₃₁) (P2).

FIG. 7. Intensity weighted size distribution of P(FPMAm₄₄-co-MAA₅₆) (P1) in DMF measured by dynamic light scattering (DLS).

FIG. 8. Intensity weighted size distribution of P(FPMAm₄₄-co-MAA₅₆) (P1) in water measured by DLS.

FIG. 9. Cyclic voltammetry of P1-CNT/Ti electrodes (with varying amounts of cross-linker) for 100 cycles in the presence of 100 mM NaClO₄. The potential range chose was from −1.1 to 1.1 V with scan rate 50 mV/s. a) P1-CNT/Ti w/0% cross-linker. a) P1-CNT/Ti w/0% cross-linker. b) P1-CNT/Ti w/5% cross-linker. c) P1-CNT/Ti w/10% cross-linker. d) P1-CNT/Ti w/20% cross-linker.

FIG. 10. Cyclic voltammetry of P1-CNT/Ti electrodes (with varying amounts of cross-linker) final 10 cycles (from over 100 cycles) in the presence of 100 mM NaClO₄. The potential range chose was from −1.1 to 1.1 V with scan rate 50 mV/s.

FIG. 11. Scanning electron microscopy (SEM) images and Energy-dispersive X-ray spectroscopy (EDS) mapping. EDS mapping of P1-CNT/Ti electrode, Pristine (Blank).

FIG. 12. The pseudo-first-order (a) and pseudo-second-order kinetics model (b) plots for Y(III) adsorption on P1-CNT/Ti.

FIG. 13. Kinetic data and modelling for the adsorption of Y(III) on P1-CNT/Ti.

FIG. 14. Langmuir isotherm (a) and Freundlich isotherm model (b) plots for Y(III) adsorption on P1-CNT/Ti.

FIG. 15. Adsorption isotherm and modeling of Y(III) adsorption on P1-CNT/Ti: Langmuir (line) and Freundlich adsorption isotherm (dots).

FIG. 16. Scanning electron microscopy (SEM) images and Energy-dispersive X-ray spectroscopy (EDS) mapping. EDS mapping of P1-CNT/Ti electrode after 1 h open circuit Y adsorption.

FIG. 17. Scanning electron microscopy (SEM) images and Energy-dispersive X-ray spectroscopy (EDS) mapping. EDS mapping of P1-CNT/Ti electrode after 1 h open circuit Y adsorption then 1 h desorption with applied potential of +0.8 V Ag/AgCl.

FIG. 18. X-ray spectroscopy for P(FPMAm-co-MAA) and P(FPMAm-co-MAA)-CNT electrodes. High-resolution XPS spectra of a Y3d, b Ce3d, c Nd4d, d Eu3d, e Gd4d, and f Dy4d before and after adsorption.

FIG. 19. XPS spectra of the polymer P(FPMAm-co-MAA) and the pristine P(FPMAm-co-MAA)-CNT electrode.

FIG. 20. Uptake and regeneration efficiency for Yttrium recovery using P1-CNT/Ti for 3 consecutive cycles.

FIG. 21. Energy consumption per desorbed moles of Y at various desorption potentials.

FIG. 22. Redox Copolymers for Electrochemically Regenerated Water Softening. System design for using electrochemical techniques for water softening.

FIG. 23. Sorption (left): Solution: 1 mL of 5 mM CaCl2)/5 mM NaCl; 5 mM Ca gives about 200 ppm. Desorption (right): Solution: 3.5 mL of 20 mM NaCl; 0.8V vs Ag/AgCl.

FIG. 24. Adsorption of Ca at various concentrations of CaCl₂ in the presence of 20 mM NaCl.

FIG. 25. Adsorption of Ca from a 5 mM CaCl₂ solution in the presence of different concentrations of competing NaCl.

FIG. 26. P(FPMAm-co-MAA)-CNT for Calcium Adsorption. Adsorption Kinetics @−0.8 V vs Ag/AgCl.

| | |
|---|---|
| Model | Parameters |

| | | |
|---|---|---|
| PFO | qₑ (mg/g) | k₁ (min⁻¹) |
| model | 22.99 | 0.197 |
| PSO | qₑ (mg/g) | k₂ (g mg⁻¹ min⁻¹) |
| model | 25.59 | 0.0095 |

FIG. 27. P(FPMAm-co-MAA)-CNT for Calcium Adsorption. Adsorption Kinetics @−0.4 V vs Ag/AgCl.

| | |
|---|---|
| Model | Parameters |

| | | |
|---|---|---|
| PFO | qₑ (mg/g) | k₁ (min⁻¹) |
| model | 23.29 | 0.164 |
| PSO | qₑ (mg/g) | k₂ (g mg⁻¹ min⁻¹) |
| model | 22.28 | 0.0135 |

FIG. 28. P(FPMAm-co-MAA)-CNT for Calcium Adsorption. Adsorption Kinetics @ O.C.

| | |
|---|---|
| Model | Parameters |

| | | |
|---|---|---|
| PFO | qₑ (mg/g) | k₁ (min⁻¹) |
| model | 18.93 | 0.3577 |
| PSO | qₑ (mg/g) | k₂ (g mg⁻¹ min⁻¹) |
| model | 17.53 | 0.0408 |

FIG. 29. CNT for Calcium Adsorption. Adsorption Kinetics @−0.8 V vs Ag/AgCl.

| | |
|---|---|
| Model | Parameters |

| | | |
|---|---|---|
| PFO | qₑ (mg/g) | k₂ (g mg⁻¹ min⁻¹) |
| model | 13.04 | 0.1342 |
| PSO | qₑ (mg/g) | k₂ (g mg⁻¹ min⁻¹) |
| model | 16.93 | 0.0089 |

### DETAILED DESCRIPTION

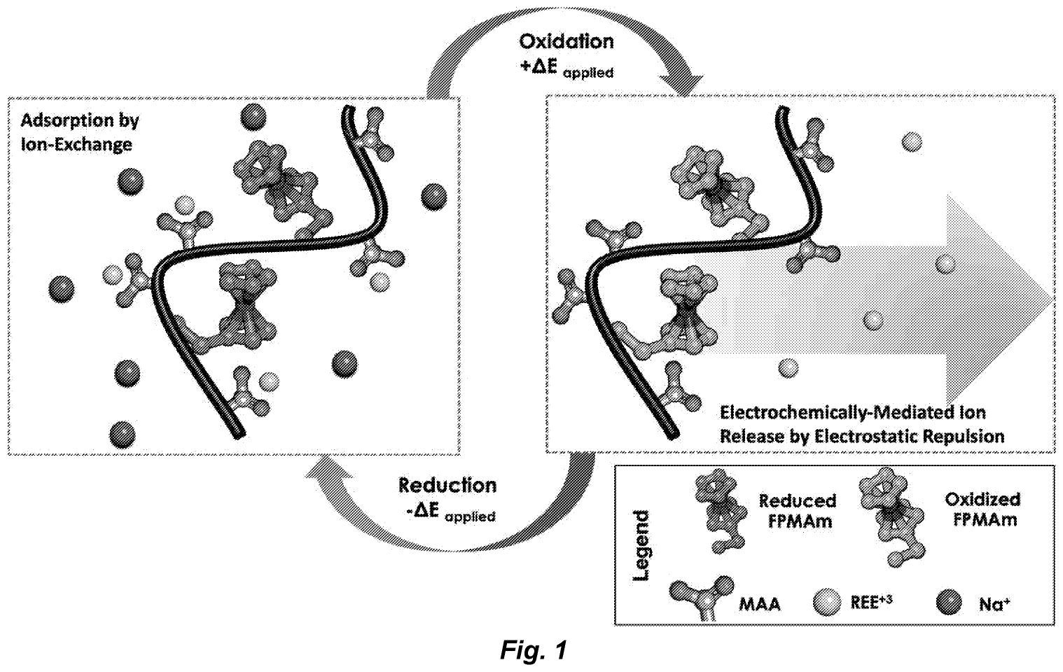

Here, we propose the combination of carboxylic groups with ferrocene groups within a single redox-copolymer, to combine traditional ion-exchange effects with redox-mediated release. Poly(methacrylic acid) (PMAA) for example has been shown to efficiently adsorb metal cations by ion exchange mechanism. At the same time, polymers with ferrocene moieties in the side chain, such as poly(vinyl ferrocene) and ferrocene based (meth)acrylates/(meth)acrylamides, show remarkable redox properties, due to the high stability of the ferrocene (Fc)/ferrocenium (Fc⁺) redox couple. We propose a system that combines the uptake of traditional ion exchange resins analogous to PMAA for REE capture, and the regeneration by electrodesorption and charge-repulsion based on ferrocenium groups (FIG. 1). Next, we describe the synthesis and characterization of a redox copolymer poly(ferrocenylpropyl methacrylamide-co-methacrylic acid) (P(FPMAm-co-MAA)), and its application for the recovery of important rare-earth elements, with a focus on yttrium (Y), dysprosium (DY), neodymium (Nd), Europium (Eu), cerium (Ce), and gandolinium (Gd). We discuss the effect of different copolymer compositions on electrochemical regeneration and adsorption uptake. This work serves as a proof-of-concept for electrochemically regenerated ion-exchange copolymers to enable more sustainable cation-selective separations.

Additional information and data supporting the invention can be found in the following publication by the inventors: J. Mater. Chem. A, 2021,9, 20068-20077 and its Supporting Information, which is incorporated herein by reference in its entirety.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, +10%, +20%, or +25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the end-points of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture.

An “effective amount” refers to an amount effective to bring about a recited effect, such as an amount necessary to form products in a reaction mixture. Determination of an effective amount is typically within the capacity of persons skilled in the art, especially in light of the detailed disclosure provided herein. The term “effective amount” is intended to include an amount of a compound or reagent described herein, or an amount of a combination of compounds or reagents described herein, e.g., that is effective to form products in a reaction mixture. Thus, an “effective amount” generally means an amount that provides the desired effect.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps.

As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation or limitations which is not specifically disclosed herein.

This disclosure provides methods of making the compounds and compositions of the invention. The compounds and compositions can be prepared by any of the applicable techniques described herein, optionally in combination with standard techniques of organic synthesis. Many techniques such as etherification and esterification are well known in the art. However, many of these techniques are elaborated in Compendium of Organic Synthetic Methods (John Wiley & Sons, New York), Vol. 1, Ian T. Harrison and Shuyen Harrison, 1971; Vol. 2, Ian T. Harrison and Shuyen Harrison, 1974; Vol. 3, Louis S. Hegedus and Leroy Wade, 1977; Vol. 4, Leroy G. Wade, Jr., 1980; Vol. 5, Leroy G. Wade, Jr., 1984; and Vol. 6; as well as standard organic reference texts such as March's Advanced Organic Chemistry: Reactions, Mechanisms, and Structure, 5th Ed., by M. B. Smith and J. March (John Wiley & Sons, New York, 2001); Comprehensive Organic Synthesis. Selectivity, Strategy & Efficiency in Modern Organic Chemistry. In 9 Volumes, Barry M. Trost, Editor-in-Chief (Pergamon Press, New York, 1993 printing); Advanced Organic Chemistry, Part B: Reactions and Synthesis, Second Edition, Cary and Sundberg (1983); for heterocyclic synthesis see Hermanson, Greg T., Bioconjugate Techniques, Third Edition, Academic Press, 2013.

The formulas and compounds described herein can be modified using protecting groups. Suitable amino and carboxy protecting groups are known to those skilled in the art (see for example, Protecting Groups in Organic Synthesis, Second Edition, Greene, T. W., and Wutz, P. G. M., John Wiley & Sons, New York, and references cited therein; Philip J. Kocienski; Protecting Groups (Georg Thieme Verlag Stuttgart, New York, 1994), and references cited therein); and Comprehensive Organic Transformations, Larock, R. C., Second Edition, John Wiley & Sons, New York (1999), and referenced cited therein.

The term “halo” or “halide” refers to fluoro, chloro, bromo, or iodo. Similarly, the term “halogen” refers to fluorine, chlorine, bromine, and iodine.

The term “alkyl” refers to a branched or unbranched hydrocarbon having, for example, from 1-20 carbon atoms, and often 1-12, 1-10, 1-8, 1-6, or 1-4 carbon atoms; or for example, a range between 1-20 carbon atoms, such as 2-6, 3-6, 2-8, or 3-8 carbon atoms. As used herein, the term “alkyl” also encompasses a “cycloalkyl”, defined below. Examples include, but are not limited to, methyl, ethyl, 1-propyl, 2-propyl (iso-propyl), 1-butyl, 2-methyl-1-propyl (isobutyl), 2-butyl (sec-butyl), 2-methyl-2-propyl (t-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like. The alkyl can be unsubstituted or substituted, for example, with a substituent described below or otherwise described herein. The alkyl can also be optionally partially or fully unsaturated. As such, the recitation of an alkyl group can include an alkenyl group or an alkynyl group. The alkyl can be a monovalent hydrocarbon radical, as described and exemplified above, or it can be a divalent hydrocarbon radical (i.e., an alkylene).

An alkylene is an alkyl group having two free valences at a carbon atom or two different carbon atoms of a carbon chain. Similarly, alkenylene and alkynylene are respectively an alkene and an alkyne having two free valences at a carbon atom or at two different carbon atoms.

The term “cycloalkyl” refers to cyclic alkyl groups of, for example, from 3 to 10 carbon atoms having a single cyclic ring or multiple condensed rings. Cycloalkyl groups include, by way of example, single ring structures such as cyclopropyl, cyclobutyl, cyclopentyl, cyclooctyl, and the like, or multiple ring structures such as adamantyl, and the like. The cycloalkyl can be unsubstituted or substituted. The cycloalkyl group can be monovalent or divalent, and can be optionally substituted as described for alkyl groups. The cycloalkyl group can optionally include one or more cites of unsaturation, for example, the cycloalkyl group can include one or more carbon-carbon double bonds, such as, for example, 1-cyclopent-1-enyl, 1-cyclopent-2-enyl, 1-cyclopent-3-enyl, cyclohexyl, 1-cyclohex-1-enyl, 1-cyclohex-2-enyl, 1-cyclohex-3-enyl, and the like.

The term “heterocycloalkyl” or “heterocyclyl” refers to a saturated or partially saturated monocyclic, bicyclic, or polycyclic ring containing at least one heteroatom selected from nitrogen, sulfur, oxygen, preferably from 1 to 3 heteroatoms in at least one ring. Each ring is preferably from 3 to 10 membered, more preferably 4 to 7 membered. Examples of suitable heterocycloalkyl substituents include pyrrolidyl, tetrahydrofuryl, tetrahydrothiofuranyl, piperidyl, piperazyl, tetrahydropyranyl, morpholino, 1,3-diazapane, 1,4-diazapane, 1,4-oxazepane, and 1,4-oxathiapane. The group may be a terminal group or a bridging group.

The term “aryl” refers to an aromatic hydrocarbon group derived from the removal of at least one hydrogen atom from a single carbon atom of a parent aromatic ring system. The radical attachment site can be at a saturated or unsaturated carbon atom of the parent ring system. The aryl group can have from 6 to 30 carbon atoms, for example, about 6-10 carbon atoms. The aryl group can have a single ring (e.g., phenyl) or multiple condensed (fused) rings, wherein at least one ring is aromatic (e.g., naphthyl, dihydrophenanthrenyl, fluorenyl, or anthryl). Typical aryl groups include, but are not limited to, radicals derived from benzene, naphthalene, anthracene, biphenyl, and the like. The aryl can be unsubstituted or optionally substituted with a substituent described below.

As used herein, the term “substituted” or “substituent” is intended to indicate that one or more (for example, in various embodiments, 1-10; in other embodiments, 1-6; in some embodiments 1, 2, 3, 4, or 5; in certain embodiments, 1, 2, or 3; and in other embodiments, 1 or 2) hydrogens on the group indicated in the expression using “substituted” (or “substituent”) is replaced with a selection from the indicated group(s), or with a suitable group known to those of skill in the art, provided that the indicated atom's normal valency is not exceeded, and that the substitution results in a stable compound. Suitable indicated groups include, e.g., alkyl, alkenyl, alkynyl, alkoxy, haloalkyl, hydroxyalkyl, aryl, heteroaryl, heterocyclyl, cycloalkyl, alkanoyl, alkoxycarbonyl, amino, alkylamino, dialkylamino, carboxyalkyl, alkylthio, alkylsulfinyl, and alkylsulfonyl. Substituents of the indicated groups can be those recited in a specific list of substituents described herein, or as one of skill in the art would recognize, can be one or more substituents selected from alkyl, alkenyl, alkynyl, alkoxy, halo, haloalkyl, hydroxy, hydroxyalkyl, aryl, heteroaryl, heterocycle, cycloalkyl, alkanoyl, alkoxycarbonyl, amino, alkylamino, dialkylamino, trifluoromethylthio, difluoromethyl, acylamino, nitro, trifluoromethyl, trifluoromethoxy, carboxy, carboxyalkyl, keto, thioxo, alkylthio, alkylsulfinyl, alkylsulfonyl, and cyano.

The term “metallocene” refers to a sandwich compound, for example, a compound comprising two cyclopentadienyl anions (C₅H₅⁻, abbreviated Cp) bound to a metal ion center (M), with the resulting general formula (C₅H₅)₂M. Some metallocenes comprise a metal plus two cyclooctatetraenide anions (C₈H₈²⁻, abbreviated cot²⁻).

The term, “repeat unit”, “repeating unit”, or “block” as used herein refers to the moiety of a polymer that is repetitive. The repeat unit may comprise one or more repeat units, labeled as, for example, repeat unit A, repeat unit B, repeat unit C, etc. Repeat units A-C, for example, may be covalently bound together to form a combined repeat unit. Monomers or a combination of one or more different monomers can be combined to form a (combined) repeat unit of a polymer or copolymer.

The term “molecular weight” for the copolymers disclosed herein refers to the average number molecular weight (Mn). The corresponding weight average molecular weight (Mw) can be determined from other disclosed parameters by methods (e.g., by calculation) known to the skilled artisan.

The copolymers disclosed herein can comprise random or block copolymers. In various embodiments, the ends of the copolymer (i.e., the initiator end or terminal end), is a low molecular weight moiety (e.g. under 500 Da), such as, H, OH, OOH, CH₂OH, CN, NH₂, or a hydrocarbon such as an alkyl (for example, a butyl or 2-cyanoprop-2-yl moiety at the initiator and terminal end), alkene or alkyne, or a moiety as a result of an elimination reaction at the first and/or last repeat unit in the copolymer.

### Embodiments of the Technology

This disclosure provides a redox-active copolymer comprising:
a) a first monomer comprising a redox group, wherein the redox-group comprises a redox-active transition metal or an organic redox-moiety, and
b) a second monomer comprising a chemical binding group that can bind a rare earth element (REE) transition metal ion or an alkaline earth metal ion, wherein the chemical binding group is an organic acid, a chelator, or an organic ligand; wherein the first monomer and second monomer form the redox-active copolymer.

In various embodiments, the redox group (Redox) comprises an organometallic and/or organic redox-group selected from the list consisting of a:
Metallocene:

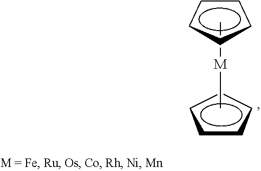

wherein M is at an oxidation state defined by b, below;
Nitroxide (aminoxyl, e.g., R₂N—O):

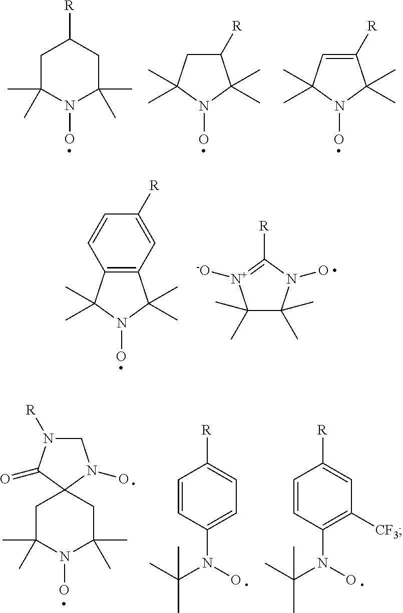

Viologen:

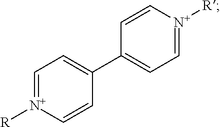

and
Phenothiazine:

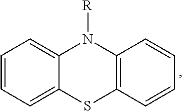

wherein R is the point of attachment to the copolymer of Formula III, below.

In various embodiments, the chemical binding group (Binder: e.g., metal or metal ion chelating groups, ion-exchange groups, etc.) is selected from the list consisting of:

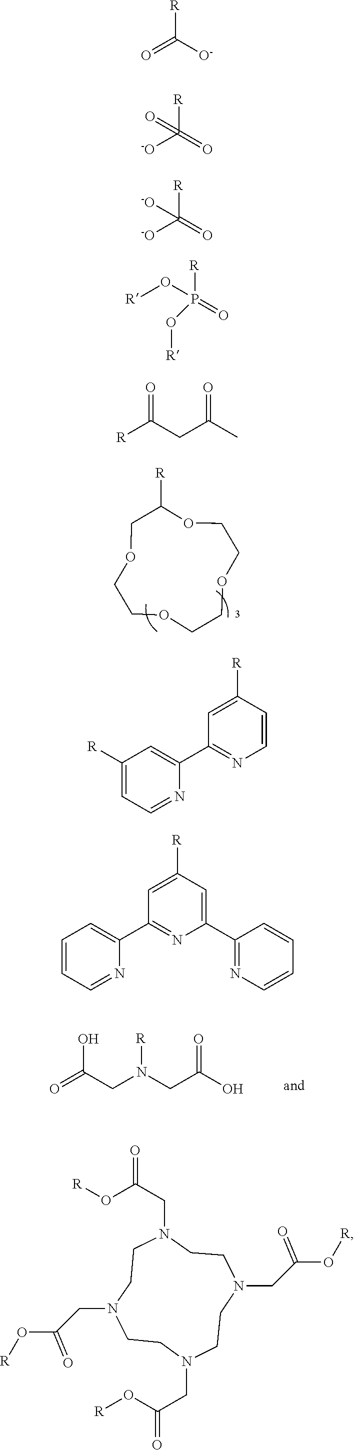

wherein R is the point of attachment to the copolymer of Formula III, below.

This disclosure also provides a redox-active copolymer comprising:
a) an organometallic (or first) monomer comprising a redox group wherein the redox group has a redox-active transition metal; or a first organic monomer comprising an organic redox-molecule (wherein the first organic monomer is not organometallic, for example a nitroxide); and
b) an organic (or second) monomer comprising a covalently bound acid group wherein the acidic group is metal ion binding moiety;
wherein the organometallic (or first) monomer and organic (or second) monomer form the redox-active copolymer.

In various embodiments, the transition metal is iron cobalt, ruthenium, nickel, or copper. In various embodiments, the redox group or organometallic monomer comprises a metallocene or an aminoxyl group. In some embodiments, the redox group or organometallic monomer comprises ferrocene or ferrocenium. In some embodiments, the organometallic monomer comprises a ferrocenylalkyl acrylamide.

In various embodiments, the acid group comprises a carboxylic acid, a phosphonic acid, or a sulphonic acid. In various embodiments, the organic monomer comprises an acrylic acid. In various embodiments, the organometallic monomer (A) and organic monomer (B) have an A:B molar ratio of about 20:80 to about 80:20. In some embodiments, the A:B molar ratio is about 50:50 to about 70:30. In some embodiments the A:B molar ratio is about 30:70, about 40:60, or about 60:40.

In various embodiments, the copolymer comprises a crosslinker. In various embodiments, the copolymer comprises 0.05 wt. % to about 0.25 wt. % of a crosslinker. In various embodiments, the crosslinker comprises a 1,3-benzenedisulfonyl moiety.

In various embodiments, the copolymer is represented by Formula I or II:

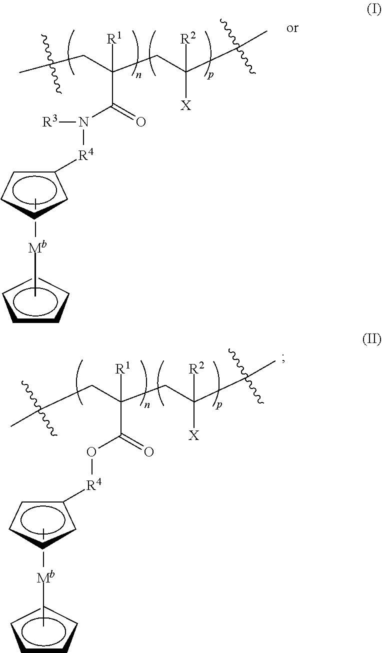

wherein
M is a transition metal;
b is the oxidation state of M wherein the oxidation state is 0-6;
R¹ and R² are each independently —(C₁-C₆)alkyl, —(C₁-C₆)cycloalkyl, or H;
R³ is H, —(C₁-C₆)alkyl, or —(C₁-C₆)cycloalkyl;
R⁴ is —(C₁-C₁₀)alkylene- or —(C₀-C₁₀)alkylene-;
X is C(═O)OH, P(═O)(OH)₂, or S(═O)₂OH;
n is 1-10,000; and
p is 1-10,000;
wherein the metallocene moiety is optionally further substituted.

In various embodiments, the copolymer is represented by Formula III:

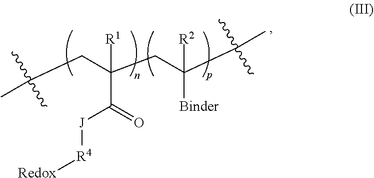

wherein J is 0 or NR³; and Redox, Binder, R¹, R², R³, R⁴, n, and p are defined above. In some embodiments, Binder is X as defined above.

In some embodiments, the copolymer is:

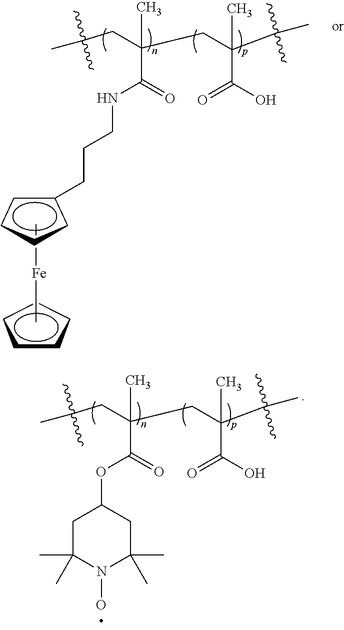

In some embodiments, R¹ and R² are CH₃, R³ is H, R⁴ is —(CH₂)₃—, and M is Fe. In some embodiments, the copolymer is a random copolymer. In some other embodiments the copolymer is a block copolymer.

Also, this disclosure provides an electrode comprising a composition of the copolymer of disclosed herein and a carbon nanotube wherein the composition is coated on a conductor. In various embodiments, the copolymer (P1) and carbon nanotube (CNT) have a P1:CNT weight ratio of about 1:1, about 2:1, or about 1:2. In various embodiments, the conductor is a titanium mesh.

Additionally, this disclosure provides a method for separating a rare earth element or for removing an alkaline earth element (Group IIA element) from a mixture comprising:
a) adsorbing a metal ion of a rare or alkaline earth element on the electrode disclosed herein under suitable adsorption conditions to separate the metal ion from the mixture, wherein the redox group of the electrode has a net charge of zero; and
b) electrochemically desorbing the metal ion from the electrode into an electrolyte under suitable desorption conditions, wherein the redox group of the electrode has been oxidized to a net charge of at least +1.

In various embodiments, the transition metal has an oxidation state of zero. In various other embodiments, the transition metal has an oxidation state of at least +1. In various embodiments the transition metal is iron. In various embodiments, iron has an oxidation state of 0, +1, +2, or +3.

In various embodiments, the rare or alkaline earth metal ion is in a mixture comprising other metal ions, wherein the other metal ions are not rare or alkaline earth metal ions. In various embodiments, the rare or alkaline earth metal ion is selectively adsorbed over the other metal ions. In some embodiments, the rare earth element or ion is cerium (Ce), gadolinium (Gd), neodymium (Nd), europium (Eu), terbium (Tb), dysprosium (Dy), and yttrium (Y). In some embodiments, the alkaline earth element or ion is beryllium (Be), magnesium (Mg), calcium (Ca), strontium (Sr), barium (Ba), and radium (Ra).

In various embodiments, the suitable adsorption conditions comprise a hydronium ion concentration of about pH 4-7. In various embodiments, the suitable desorption conditions comprise applying a potential to the electrode of about +0.4 V to about +1 V or about −0.8 V to about +1 V versus an Ag/AgCl reference electrode. In various embodiments, the method further comprises, c) reducing the oxidized redox group of the electrode under suitable reduction conditions from the at least +1 charge to a charge of zero.

### Results and Discussion

Synthesis and Characterization of P(FPMAm-co-MAA). To overcome the challenge of regeneration of traditional carboxylic acid-based absorbents for REEs, we aimed to combine the carboxylic acid moiety with a redox-active ferrocene moiety in a copolymer. The electrochemical oxidation of the neutral ferrocene to the positively charged ferrocenium ion should introduce enough positive charges on the polymer to compensate the negative charges of the carboxylate anions, and consequently displace the REE cations once bound. To achieve this goal, methacrylic acid (MAA) was chosen as the carboxylic acid monomer, due to its large-scale commercial availability and low cost. Ferrocenylpropyl methacrylamide (FPMAm) was chosen as the ferrocene-containing monomer, because it has proved to have a remarkable cycling stability in aqueous redox flow batteries and does not have limitations of vinyl ferrocene in a free radical polymerization process.

The synthesis of FPMAm starting from ferrocene (Scheme 1) was improved to increase the overall yield from 51% reported previously (AdvancedEnergy Materials, 2020, 10, 2001825), to 65%. The limitation of the previous synthesis was the reduction of the nitrile to the amine with LiAlH with a yield of only 60%. By combining this step and the hydrogenation of the C═C double bond into a single hydrogenation step using Raney-Ni as catalyst the yield was improved to 86% and the synthesis shortened by a whole step. Further improvements were achieved by replacing the time and resource intensive chromatographic purification of the 2-cyanovinyl ferrocene with a simple recrystallization protocol and replacing the expensive methacryoyl chloride with much cheaper methacrylic anhydride for the last step of the synthesis. FPMAm and MAA were copolymerized by free radical copolymerization (Scheme 2), yielding copolymer with different ratios of FPMAm and MAA and thus different ratios of sites for REE binding and redox-active groups.

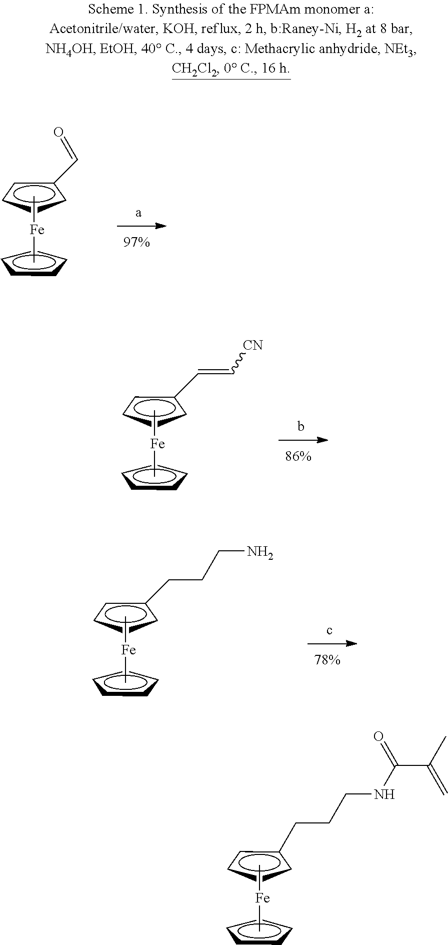

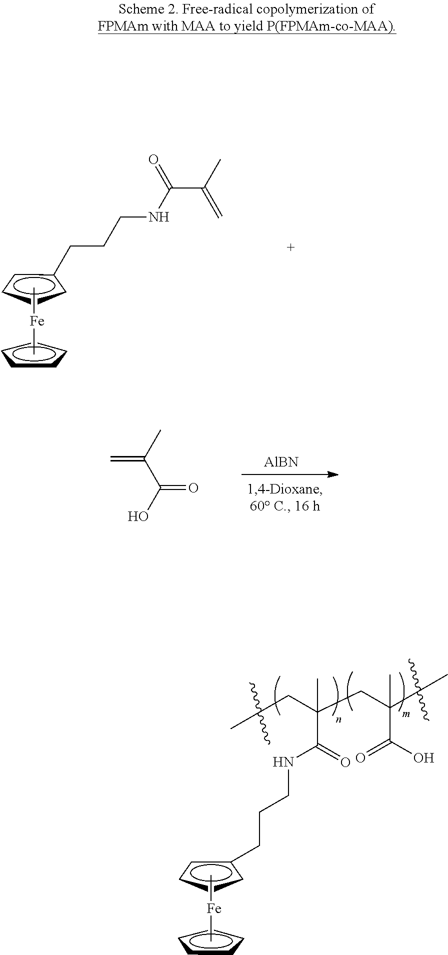

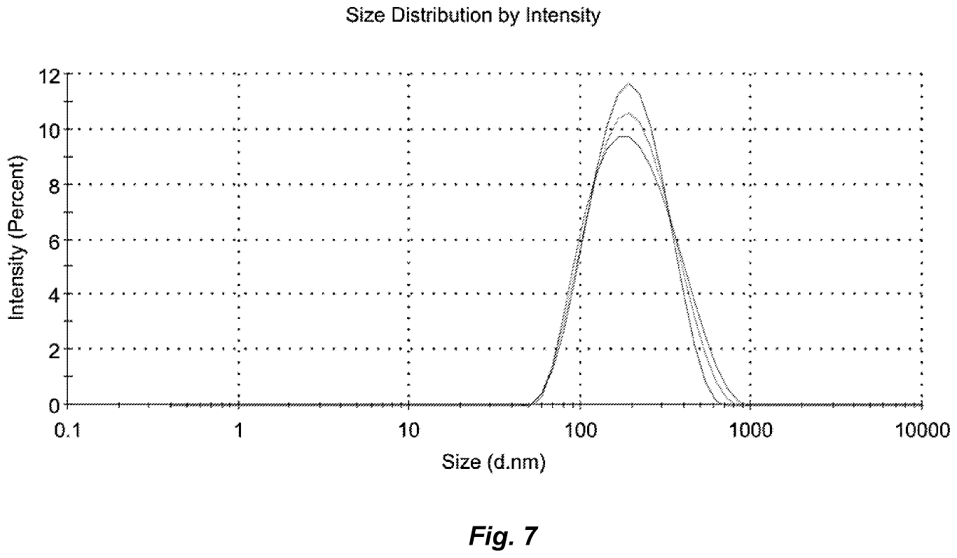

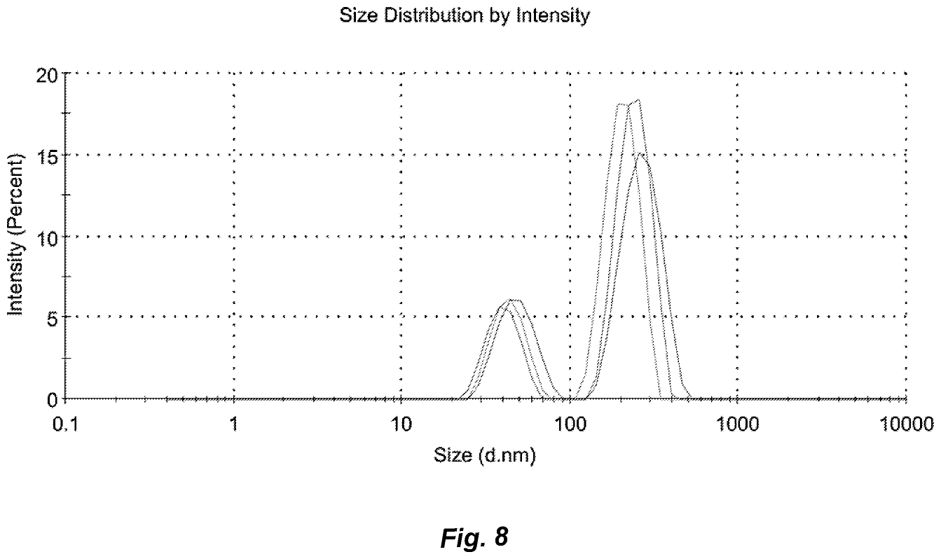

The ratio of monomers was analysed by ¹H-NMR spectroscopy and the P(FPMAmₓ-co-MAA₁₋ₓ) used in this study are summarized in Table 1, with x indicating the content of FPMAm in mol-%. Furthermore, a copolymer of MAA and hydrophobic benzyl methacrylate (P(BzMA₅₂-MAA₄₈)) was synthesized as a non-redox active control. Measurement of the molecular weight was attempted by gel permeation chromatography, with only for the polymer with low MAA content (P2) yielding consistent results (FIG. 6). The polymer with a higher MAA content (P1) formed micelles in DMF—as shown by dynamic light scattering (DLS) measurements (FIG. 7). This micellization was due to the high content of carboxylate groups, which are not well solubilized in DMF, and the organosoluble FPMAm repeating units stabilizing the micelles. When P1 was dissolved in water it also forms micelles (FIG. 8), with the hydrophobic ferrocene moieties forming the core of the micelles.

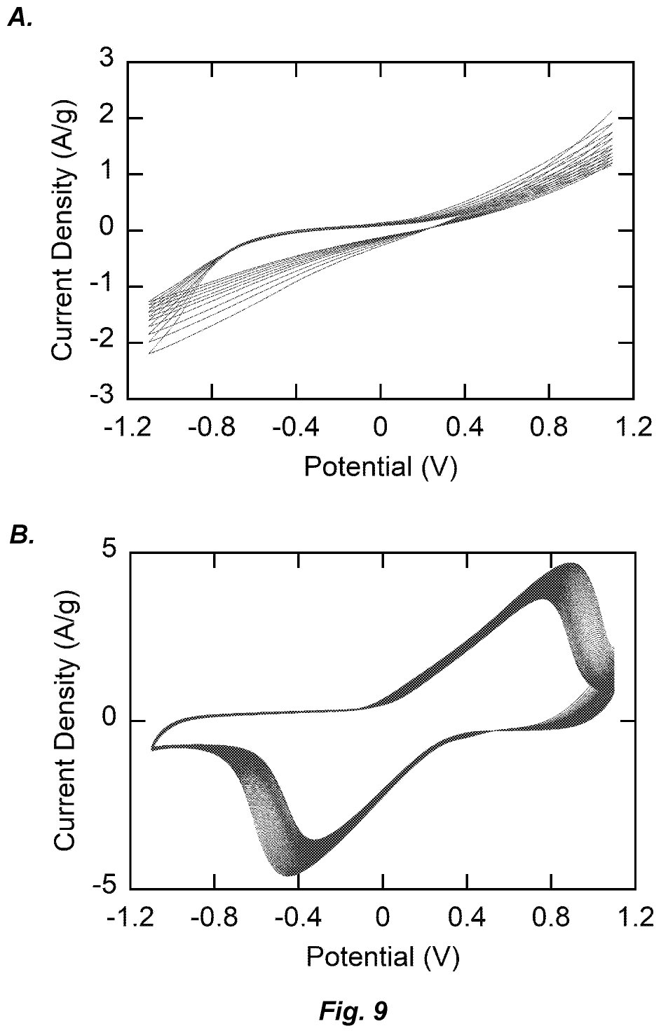

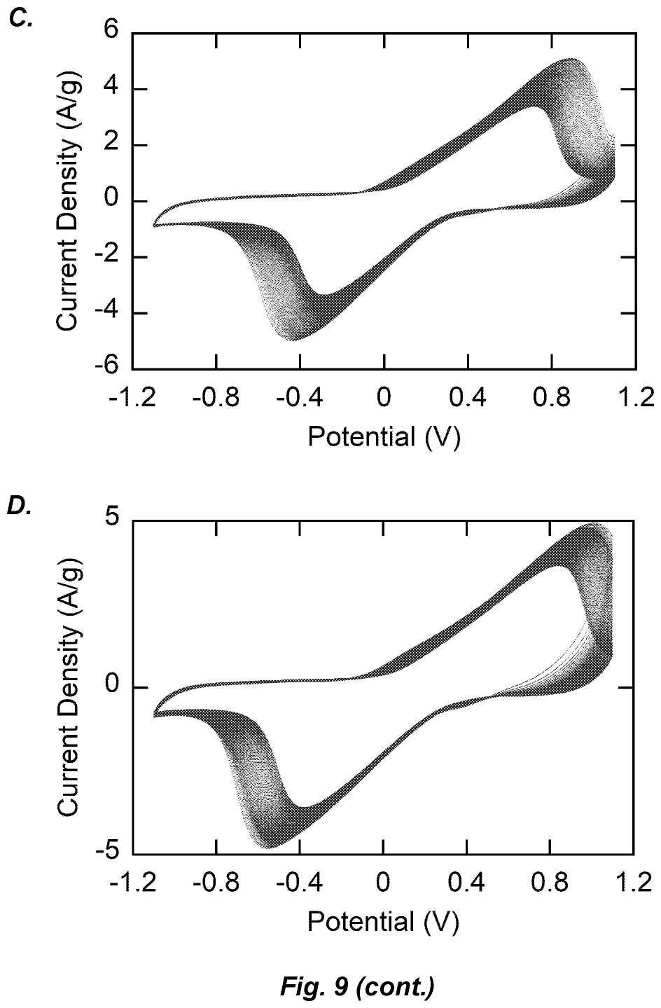

Fabrication and characterization of P(FPMAm-co-MAA)-CNT Electrodes. The main challenge in the fabrication of stable electrodes for use in water is the water solubility of the polymers—especially in the oxidized state. To prevent dissolution of the polymer, crosslinking of the film was performed. 1,3-Benzenedisulfonyl azide (1,3-BDSA) was used as a crosslinker. By heating to temperature>120° C. the sulfonyl azide groups of this crosslinker formed reactive nitrene species that inserted into C—H bonds of the polymer and thus crosslinking the polymer. Without crosslinker, P1 was seen to quickly dissolve out of the P1-CNT electrodes due to the water solubility of PMAA (FIG. 9a).

TABLE 1
Overview of the copolymer composition.

| | Monomer ratio [mol-% FPMAm] | |
|---|---|---|
| | Target^{a} | Measured^{b} |
| P(FPMAm₄₄-CO-MAA₅₆) (P1) | 50 | 44 |
| P(FPMAm₆₉-co-MAA₃₁) (P2) | 70 | 69 |
| P(FPMAm₂₆-co-MAA₇₄) (P3) | 30 | 26 |
| PFPMAm (P4) | 100 | 100 |
| P(BzMA₅₂-MAA₄₈) (P5) | 50^{c} | 52^{c} |

^{a}Targeted monomer ratio at the start of the reaction.
^{b}The FPMAm content was determined by ¹H-NMR spectroscopy.
^{c}Mol-% BzMA.

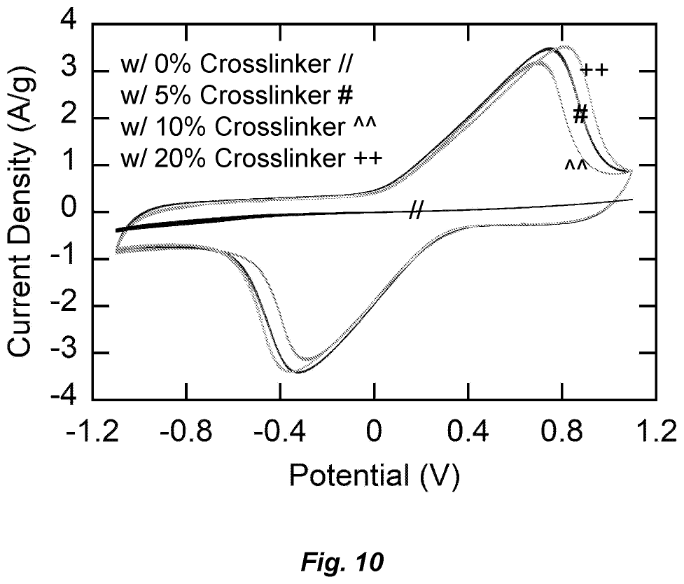

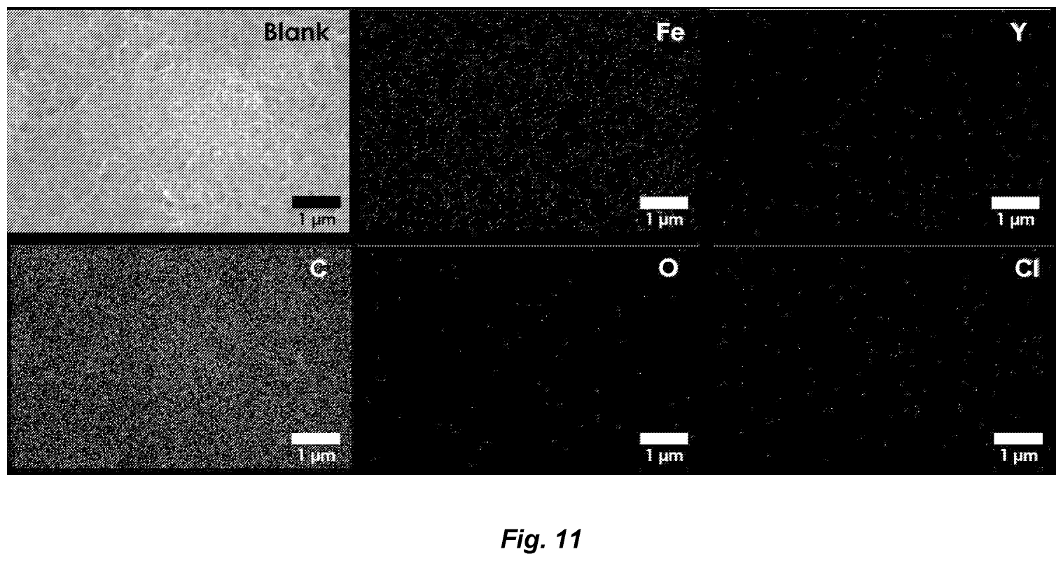

The stability and redox activity of the P1-CNT electrode was investigated using cyclic voltammetry (CV) (FIGS. 9 and 10). Redox activity in the redox-copolymer was confirmed through CVs, with clear reversible oxidation and reduction of the ferrocenyl groups observed. Crosslinking with 1,3-BDSA was used to keep P1 (and the other MAA containing polymers) from dissolving into the aqueous solution and therefore stabilize the P1-CNT electrodes. The ratios of cross-linking reagent/P1 tested were 0, 0.05, 0.1, and 0.2. Although the P1-CNTi electrodes, with crosslinking, see some initial loss of active material due to incomplete crosslinking, the charge of the electrodes stabilizes quickly and leads to a stable operational charge of ˜80% of the initial charge. On the other hand, the polymer in the P1-CNT electrode without crosslinking was quickly dissolved completely (FIG. 9 and FIG. 10), showing the importance of optimizing crosslinking strength. The optimal ratio 0.1 of cross-linking reagent/P1 (and all polymers containing MAA) used throughout the rest of the work. The surface morphology and elemental mapping images of the P1-CNT electrode were carried out (FIG. 11 and Table 2) to confirm the stability of the polymer in the coating and show the microporous morphology of the electrodes.

REE Adsorption: Investigation of Polymer Structure and Target REE Screening. Adsorption experiments for Y, and additional Na ions, were performed on several different adsorbents, including P(FPMAm)-CNT (ferrocene functional group control), P(FPMAm₇₀-co-MAA₃₀)-CNT, P(FPMAm₂₅-co-MAA₇₅)-CNT, P(BzMA₅₂-MAA₄₈)-CNT (non-redox active control), as well as just CNT, to evaluate the effect of the polymer structure. All tests for all adsorbents and all REEs were performed under the same conditions (10 mL of aqueous solution containing 1 mM RE(Cl)₃ and 20 mM NaCl, 1 h run time, open circuit, pH of 6, at room temperature).

TABLE 2
SEM-EDS analysis of P1-CNT/Ti electrodes (a) Pristine
(Blank), (b) After 1 h open circuit Y adsorption,
(c) After 1 h open circuit Y adsorption then 1 h desorption
with applied potential of +0.8 V Ag/AgCl.

| | | Blank (a) | | Ads-Y (b) | | Des-Y (c) | |
|---|---|---|---|---|---|---|---|
| | | Atomic | Con | Atomic | Con | Atomic | Con |
| Elt. | Line | % | wt. % | % | wt. % | % | wt. % |
| C | Ka | 89.151 | 77.342 | 92.240 | 78.022 | 93.000 | 80.846 |
| N | Ka | 0.000 | 0.000 | 0.000 | 0.000 | 0.000 | 0.000 |
| O | Ka | 4.298 | 4.967 | 3.588 | 4.043 | 2.238 | 2.592 |
| Na | Ka | 3.645 | 6.052 | 0.267 | 0.432 | 0.144 | 0.239 |
| S | Ka | 0.119 | 0.276 | 0.052 | 0.118 | 0.045 | 0.103 |
| Cl | Ka | 0.051 | 0.132 | 0.349 | 0.870 | 1.690 | 4.336 |
| Fe | Ka | 2.654 | 10.706 | 2.329 | 9.161 | 2.787 | 11.264 |
| Y | La | 0.082 | 0.525 | 1.174 | 7.353 | 0.096 | 0.619 |

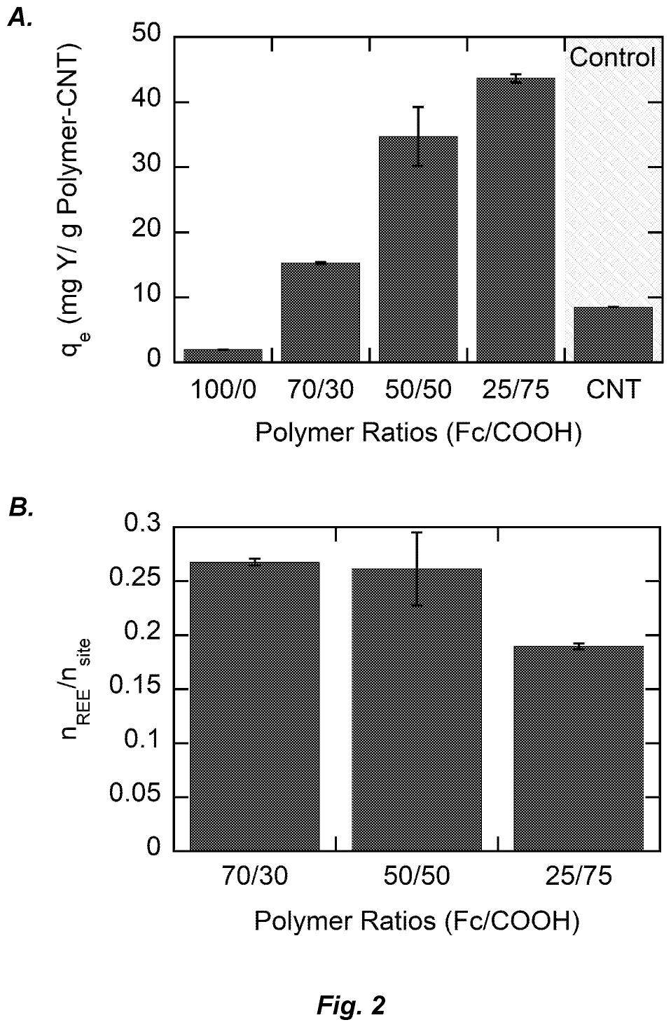

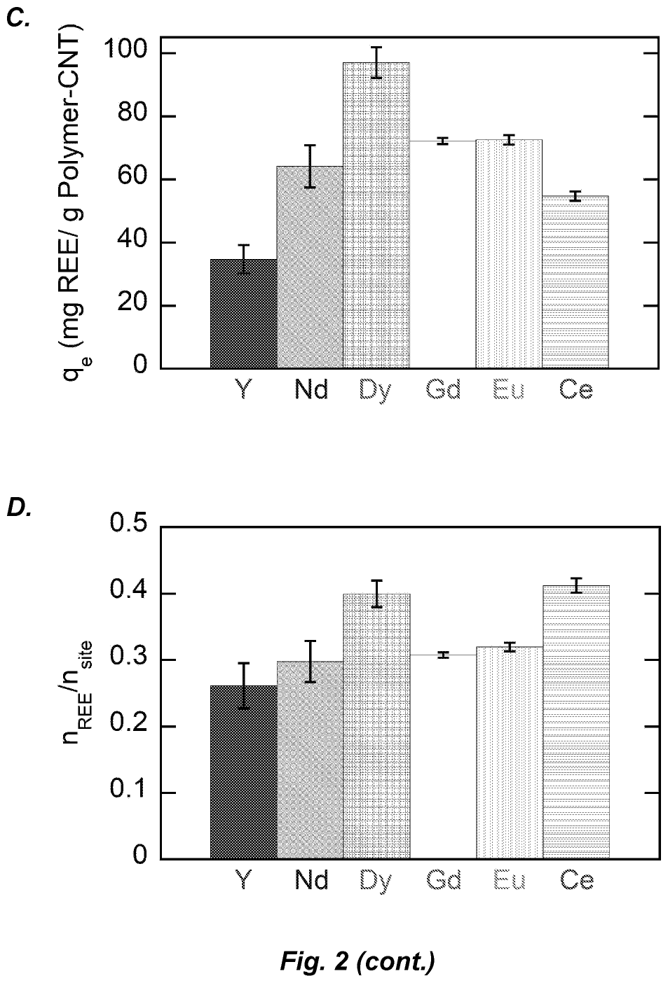

Based on experimental results (FIG. 2a), Y ion uptake increased with increasing methacrylic acid content carboxylic acid moieties. Negligible Y uptake was observed on electrodes coated with active material without carboxylic acid groups (P(FPMAm)-CNT and CNT controls), providing strong evidence that carboxylic acid moieties were solely responsible for Y interaction, and the ferrocenyl groups and CNT provided little to no uptake by themselves. The ratio of Y ion uptake to carboxyl adsorption sites (FIG. 2b) was close to the theoretical value of ⅓ for the formation of a RE(RCOO)₃ complex, showing the high accessibility and utilization of the redox-copolymer adsorption sites. The detailed description of the adsorption site calculation is given in Example 4). P1 and P(FPMAm₇₀-co-MAA₃₀) (P2) have utilized most REE binding sites within 1 h. P(FPMAm₂₆-co-MAA₇₄) (P3) showed a slightly lower binding site utilization. This is could either indicate a slower adsorption kinetics or be attributed to increased steric or columbic interactions. Adsorption experiments of REEs of interest (Y, Nd, Eu, Gd, Dy, and Ce) with Na ions were performed on P1-CNT electrodes. Nd, Eu, Gd, Dy, and Ce, were tested under the same conditions as yttrium (10 mL of aqueous solution containing 1 mM RE(Cl)₃ and 20 mM NaCl, 1 h run time, open circuit, pH of 6, room temperature). All REEs tested showed significant uptake using P1-CNT (FIG. 2c), with the ion to adsorption site ratio close to ⅓ as well (FIG. 2d), indicating similar mechanisms for these trivalent cations. Dy and Ce shoed slightly more adsorbed ions per adsorption site, indicating that fewer carboxylic acid groups were binding each cation, which may hint at possible other mechanisms at play with these two elements. Further investigation on the ligand binding will be carried out in future work for these elements.

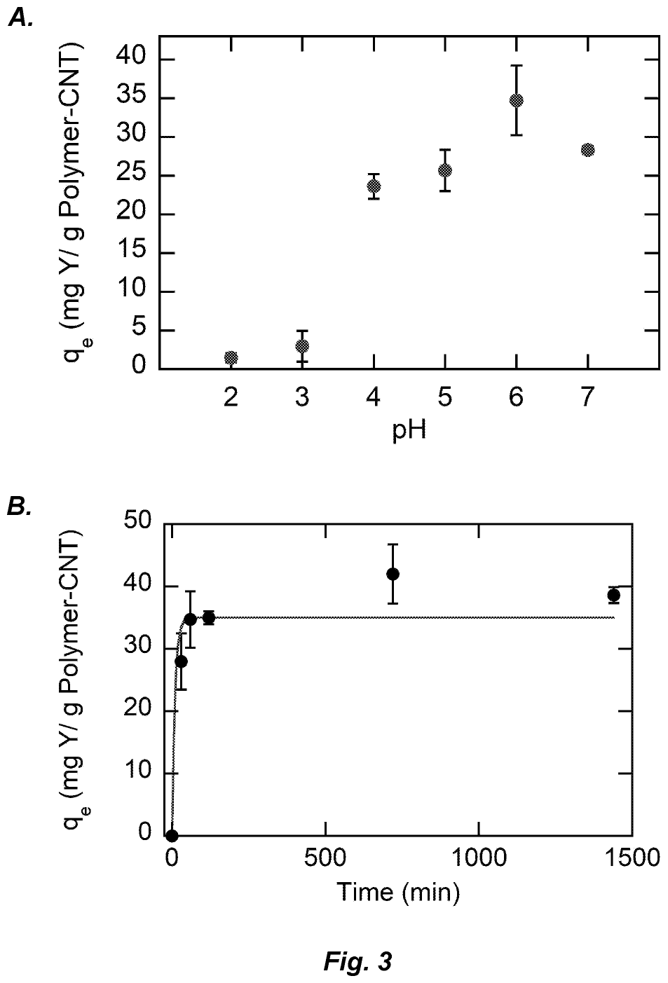

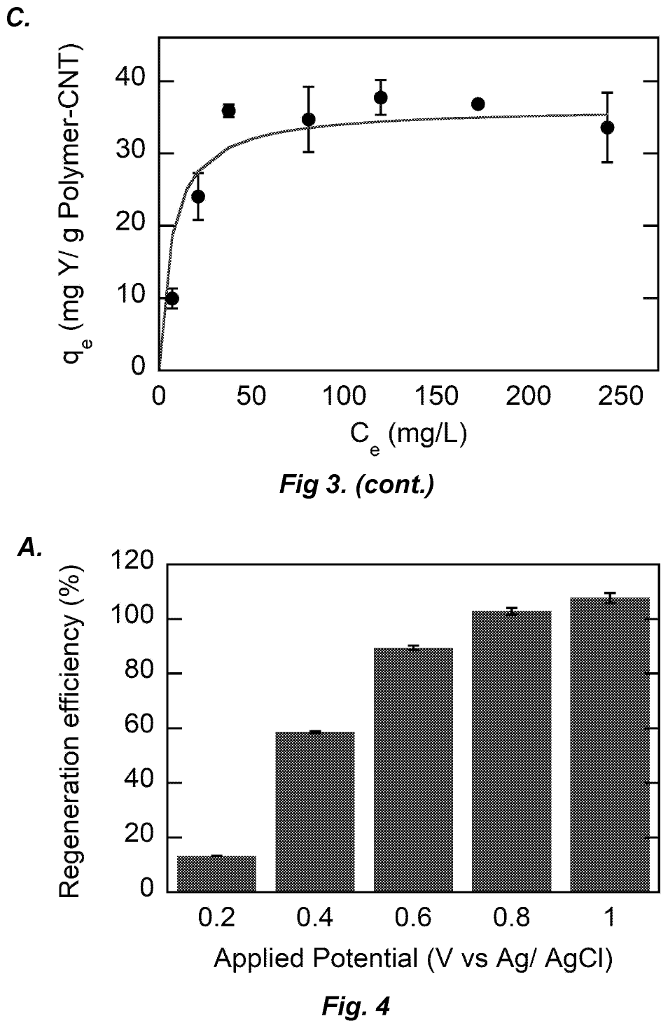

Effects of Solution pH. The pH of the solution is a major factor affecting the degree of protonation, and thus the adsorption capacity of carboxylic acid-based absorbents. The effect of pH on the adsorption of Y(III) was investigated in a pH range of 2-7. Precipitation of insoluble REE hydroxides at a pH above 7 limits the usability under basic conditions. The adsorption of Y(III) on P1-CNT had a strong pH-dependence, as shown in FIG. 3a. There was little to no Y(III) adsorption for pH<4 since the carboxylic acid groups are fully protonated at low pH and the pKa of free PMAA being around 4.7. Increasing pH results in deprotonation of absorbent and therefore an increase in active absorption sites available for REE cations. The highest uptake was observed at pH 6 (adsorption capacity of 34.7 mg Y/g P1-CNT).

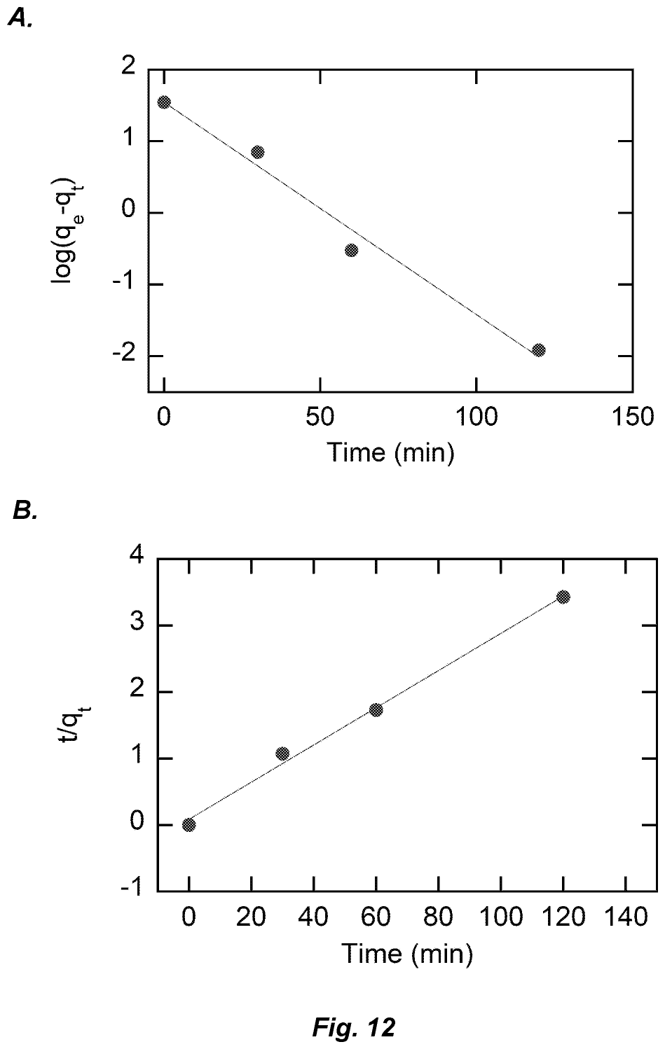

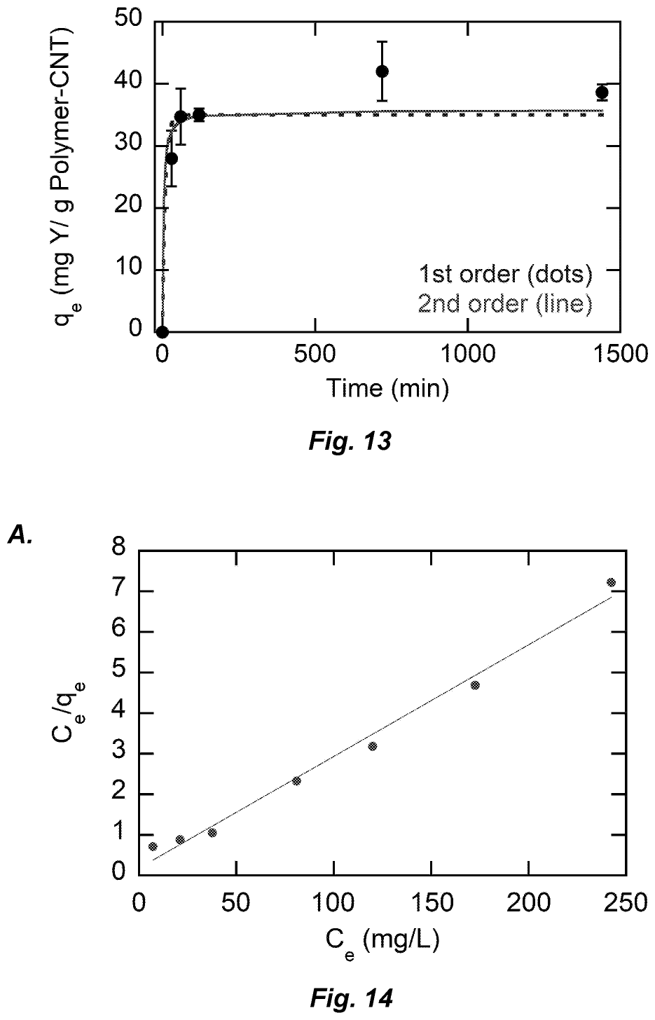

Adsorption Kinetics. To measure the kinetics of Y(III) adsorption over P1-CNT electrode, the adsorption was monitored at different contact times from 0 to 24 h, as shown in FIG. 3b. The adsorption capacity was shown to reach equilibrium within 60 min. To evaluate the adsorption process of Y(III) for P1-CNT electrodes, pseudo-first-order (PFO) and pseudo-second-order (PSO) kinetic models were used to fit the experimental kinetic data. The detailed description of the kinetic models is given in Example 4, with fitted plots presented in FIG. 12 and FIG. 13. The parameters of the PFO and PSO models and the correlation coefficients (R²) estimated using the two models are given in Table 3.

TABLE 3
Adsorption Kinetic Model Constants for
Adsorption of Y(III) on P1-CNT/Ti.

| Model | Parameters | | R² |
|---|---|---|---|
| pseudo-first-order model | qₑ (mg/g) | k₂ (g mg⁻¹ min⁻¹) | 0.9817 |
| | 35.01 | 0.0682 | |
| pseudo-second-order model | qₑ (mg/g) | k₂ (g mg⁻¹ min⁻¹) | 0.9951 |
| | 35.75 | 0.0088 | |

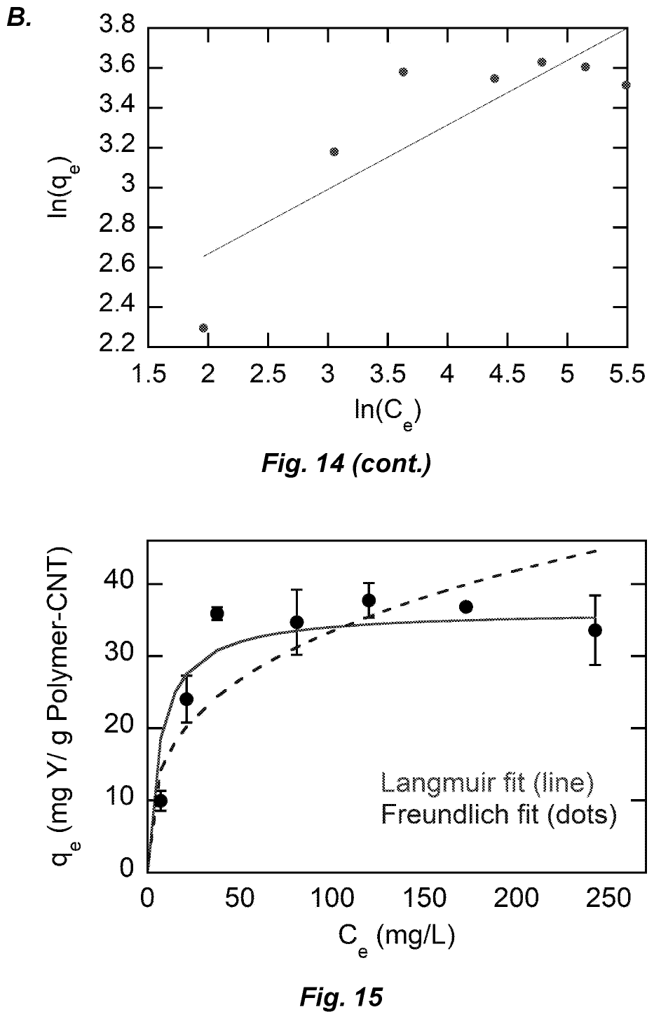

Adsorption Isotherm. The adsorption data was fitted with Langmuir or Freundlich. The detailed description of the isotherm models is given in Example 4, with fitted plots presented in FIG. 14 and FIG. 15. Obtained isotherm constants, fitted to the two models for Y(III) adsorption isotherms of P1, are summarized in Table 4. The redox-copolymers displays Langmuir adsorption behaviour, as shown in FIG. 3c, reflecting a site-based adsorption model (R²=0.987).

TABLE 4
Adsorption Isotherm Model Constants for
Adsorption of Y(III) on P1-CNT/Ti.

| | | |
|---|---|---|
| Isotherm | Parameters | R² |

| | | | |
|---|---|---|---|
| Langmuir | qₘₐₓ (mg/g) | K_{L} (L/mg) | 0.9871 |
| | 36.35 | 0.15 | |
| Freundlich | n | K_{F} (mg/g) | 0.7088 |
| | 3.09 | 7.54 | |

Adsorption Selectivity. Adsorption selectivity was evaluated through the relative separation factors (RSF) between the target elements, defined by:

$$R S {F}_{A / B} = \frac{{( [ A ] / [ B ] )}_{a d s}}{{( [ A ] / [ B ] )}_{s o l}} . \qquad ( 1 )$$

Here ([A]/[B])_{ads} is the ratio of the two competing ions adsorbed and ([A]/[B])ₛₒₗ is the ratio of the two competing ions present in the aqueous solution at equilibrium adsorption. RSF greater than 1 indicates higher selectivity of A compared to B, while RSF less than 1 indicates higher selectivity of B compared to A. The selectivity of P1-CNT was screened for Y(III) against Na⁺ ions. P1-CNT was immersed in an aqueous solution, containing 1 mM RE(Cl)₃ and 20 mM NaCl, for 1 h. Table 5 shows the RSF obtained using P1-CNT, where XPS and ICP analysis was used to calculate the adsorbed ion ratio. The final concentration of NaCl in solution is assumed to have no significant changes from the initial values due to the high solution concentration levels compared to its uptake. Even with the higher concentration of Na⁺, the REE ions showed a stronger binding to the adsorption sites, following expected behaviour of these selective anionic ligands. These results indicated that P1-CNT could remove REEs from significant excess of competing ions. Selectivity of P1-CNT between REEs also was investigated through competitive adsorption tests with Y vs Ce and Y vs Dy. For these competitive adsorptions, we used 1 h contact time in 10 mL aqueous solution, with 1 mM for each of the REE salts (and without competing NaCl). RSF for Y/Ce and Y/Dy, obtained using ICP measurements, are shown in Table 5. The carboxylic acid ligands serve as the models for proof-of-concept in the current work, with future incorporation of more selective ligands between REEs being equally flexible through the synthetic pathways presented above.

TABLE 5
Estimated Relative Separation Factors using P1-CNT Electrodes.

| Ion A | Ion B | RSFA/B |
|---|---|---|
| Y⁺³ | Na⁺ | 610.3 ± 6.33 |
| Dy⁺³ | Y⁺³ | 1.85 ± 0.087 |
| Y⁺³ | Ce⁺³ | 1.35 ± 0.046 |

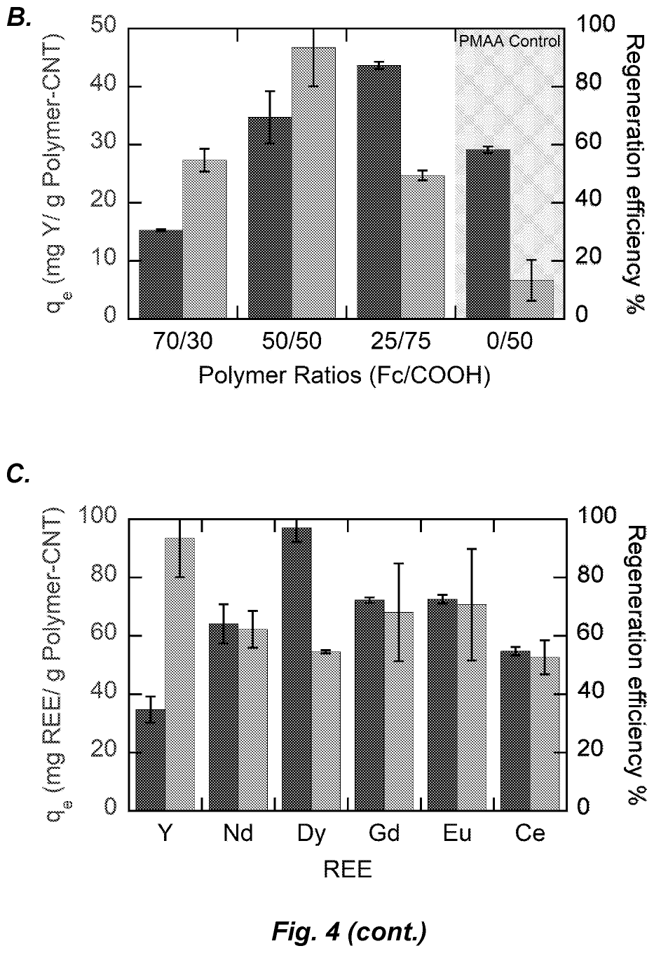

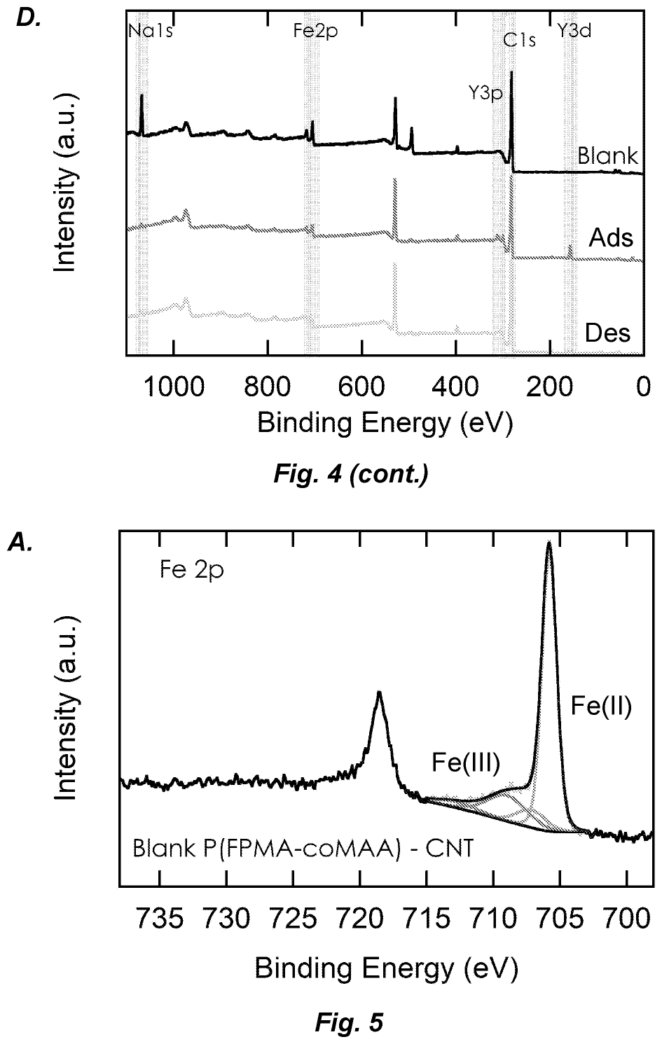

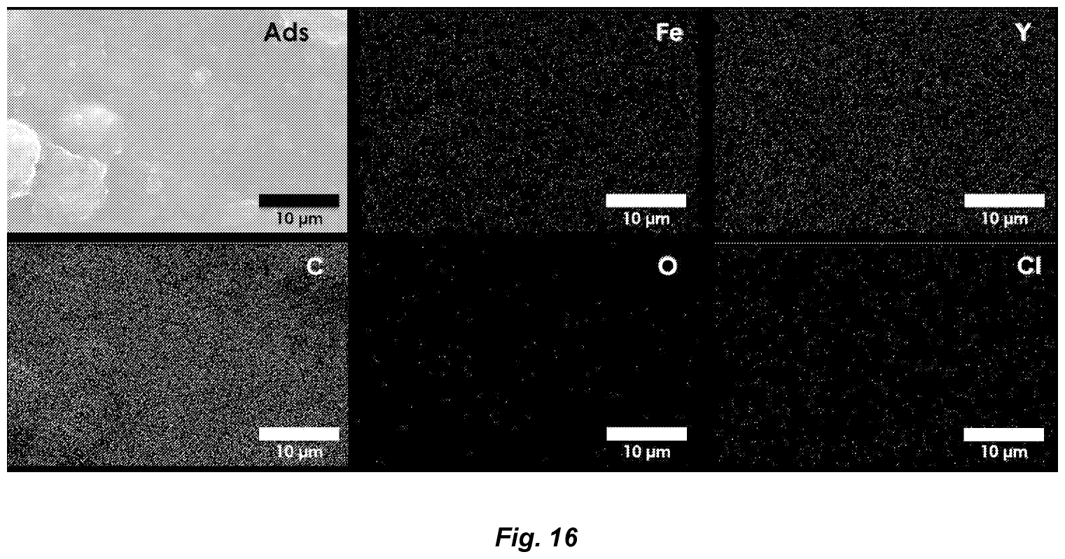

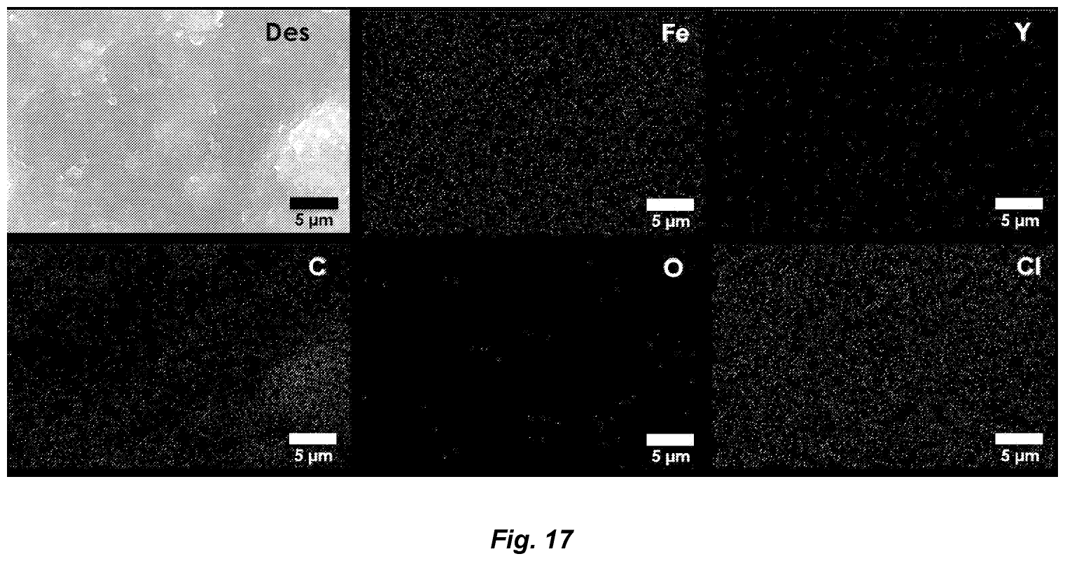

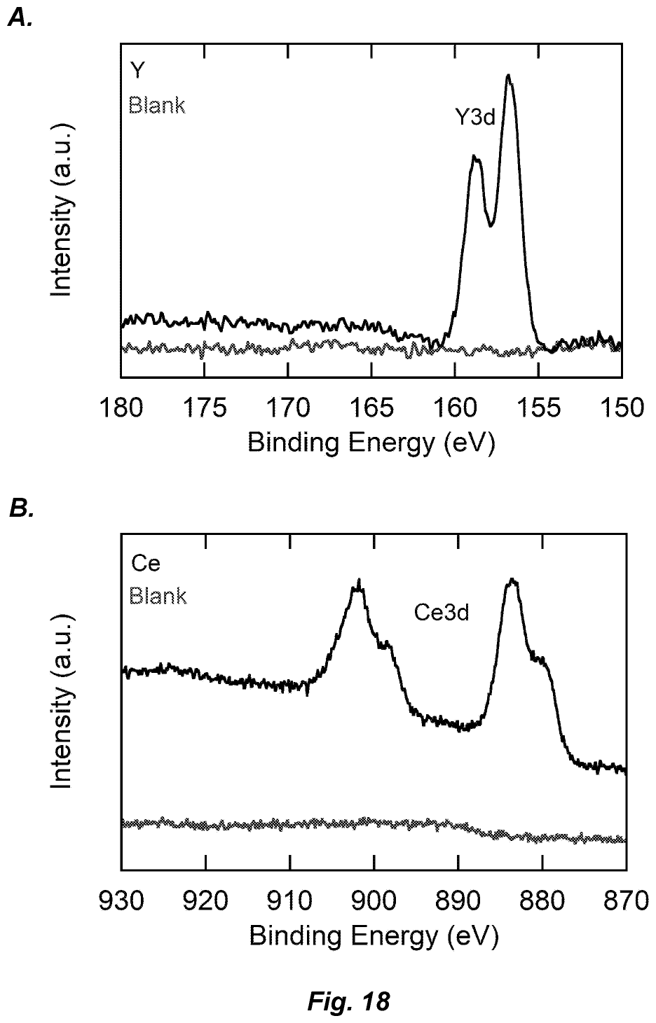

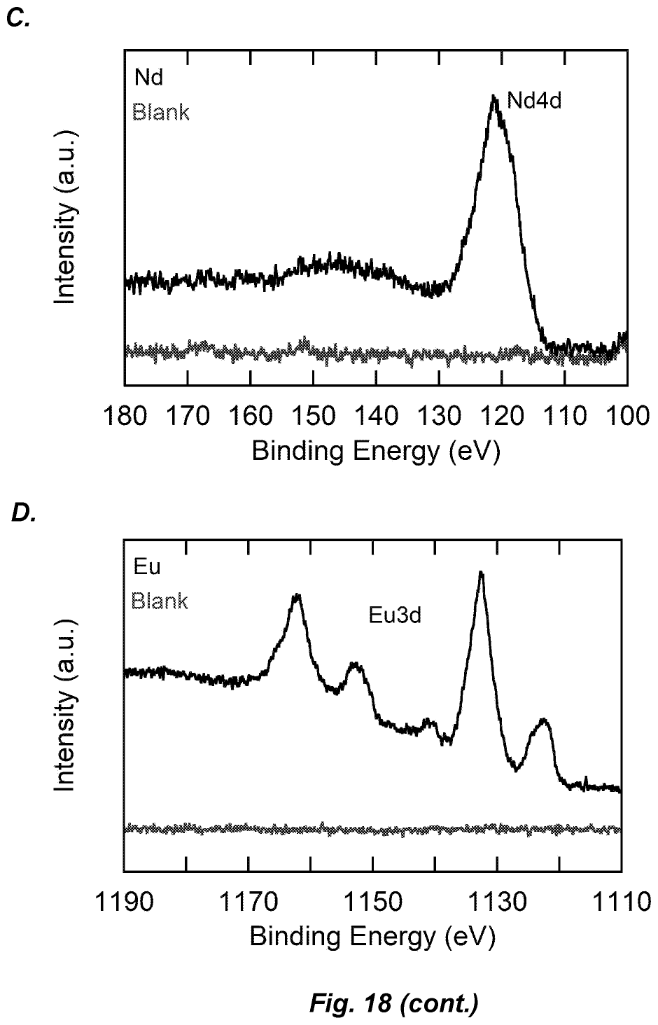

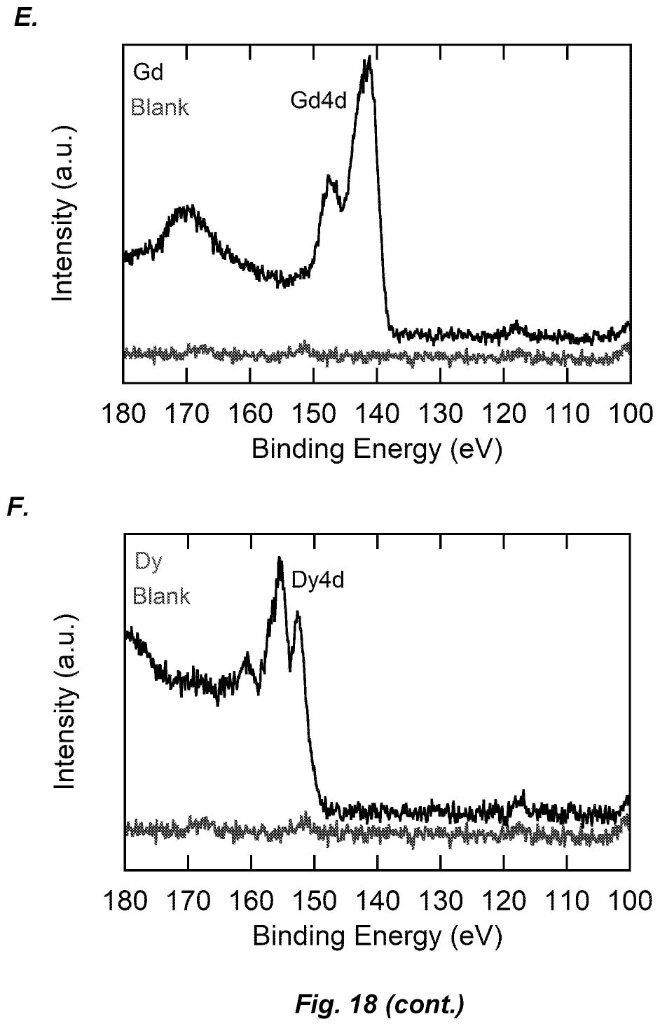

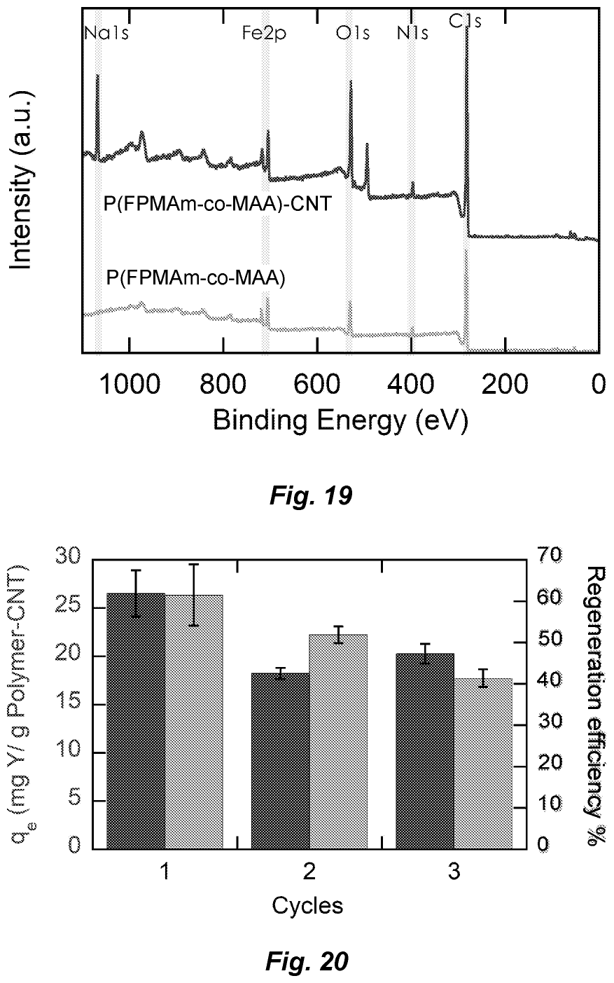

Redox-Mediated Regeneration and Cycling. Most importantly, we evaluate the electrochemical regeneration of our redox-copolymer systems for the bound REEs. In practical column adsorption applications, stripping of adsorbed ions is required for reuse of adsorbent in subsequent adsorption. While traditional ion exchange resins require stripping with strong acid or base, our proposed combination of carboxylic acid and redox active ferrocene moieties within a single copolymer allows for solely electrochemically controlled regeneration of the adsorbent. Bound REE ions can be released into solution through electrostatic repulsion of by the positively charged ferrocenium ions, through electrochemically driven oxidation. The electrosorption of REE loaded P1-CNT electrodes was investigated under various applied positive potentials (FIG. 4a) for 1 h for releasing adsorbed Y(III) into 20 mM NaCl electrolyte. As depicted in FIG. 4a, P1-CNT exhibited almost full regeneration when applying +0.8V during the first cycle desorption without using any acid or other stripping chemical additives. The successful adsorption and release of Y(III) on P1-CNT was also confirmed through X-ray photoelectron spectroscopy (XPS) (FIG. 4d) and scanning electron microscopy (SEM) and energy-dispersive spectroscopy (EDS) analyses (FIGS. 11, 16 and 17), by seeing the increase in yttrium content after adsorption, and its close to complete removal after electrochemical regeneration. Regeneration of P1-CNT was also tested with other REEs (FIG. 4c), with loaded P1-CNTi released adsorbed RE(III) into 20 mM NaCl applying +0.8 V for 1 h. Regeneration parameters for P1-CNT were set using Y(III) as the model for REE ions.

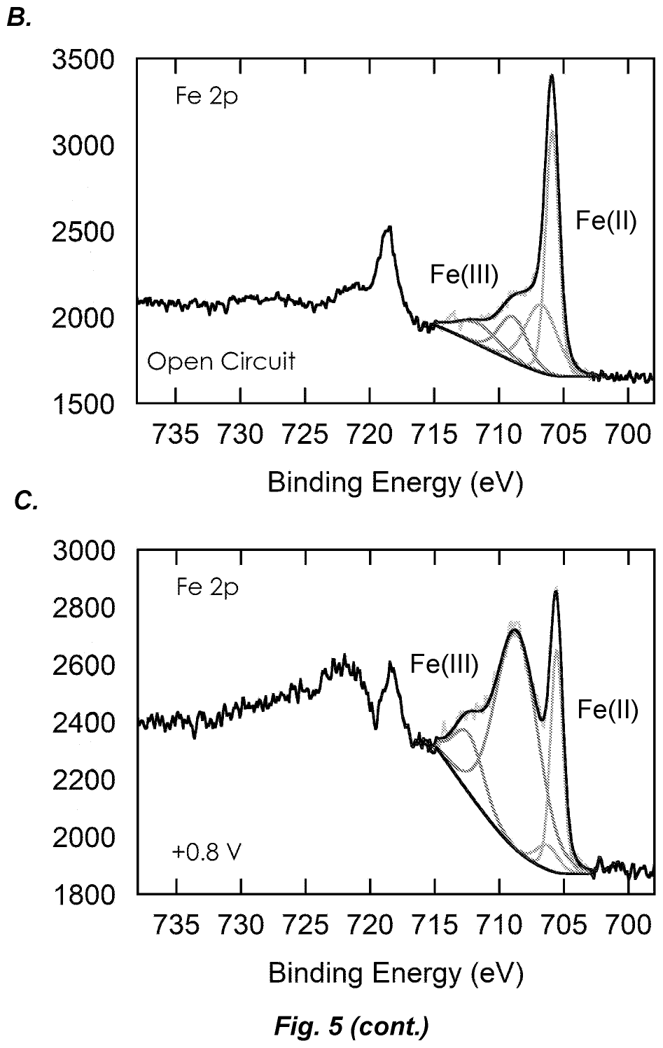

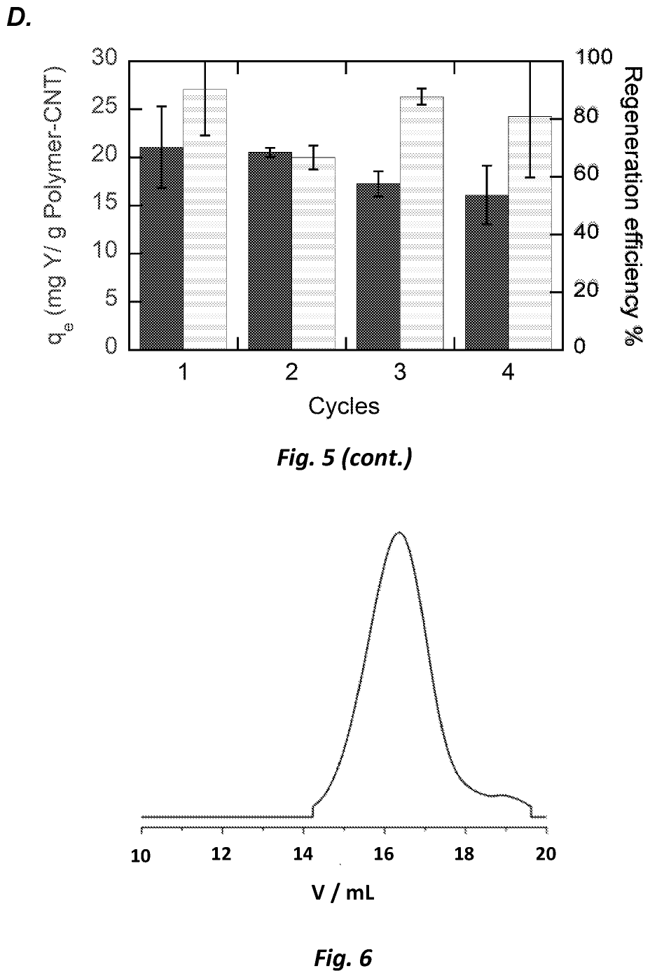

To prove the importance of the redox-active groups for release of REE ions, a copolymer with 52 mol-% BzMA instead of FPMAm (P(BzMA₅₂-MAA₄₈), P5) was used. P5-CNT showed a similar uptake as P1, but poor regeneration at 0.8 V (FIG. 4b), conforming that the release is tremendously enhanced by the redox-active ferrocene moieties. Experiments varying the ratio of carboxylic to ferrocenyl groups showed that with increasing carboxylic acid groups (binding sites) content compared to ferrocene desorption became less efficient (FIG. 4b), reaffirming the idea that the oxidation of ferrocene groups to ferrocenium cations is the driving force of the ion desorption process. XPS was used to estimate the ratio between reduced and oxidized ferrocene sites from the high resolution Fe2p spectra of the surface of P1-CNT (FIG. 5a-c). The oxidation state ratio of Fe on the surface of pristine (or blank) P1-CNT and P1-CNT after adsorption of Y(III) in 1 mM YCl₃ and 20 mM NaCl for 1 h were similar to each other, with both showing most of the Fc sites were in a reduced state. After regeneration (desorption) of the P1-CNT electrode via chronoamperometry at +0.8 V (vs Ag/AgCl) in 20 mM NaCl for 1 h, over 70% of the Fc sites were oxidized. This further suggests the mechanism for desorption can be attributed to the oxidized Fc⁺.

Along with regeneration, reusability of P1-CNT electrode is needed. As XPS analysis suggested in FIG. 5a-c, the number oxidized Fc⁺ increased after the application of positive potential during regeneration. To allow for sufficient uptake in following cycles, the oxidized Fc⁺ needs to be reduced back to Fc for starting a new cycle of REE adsorption. Reducing the P1-CNT electrode completely is crucial to prevent excessive positive charges from repelling the REE cations, limiting the REE uptake.

The results of four adsorption-desorption cycles are shown in FIG. 5d. P1-CNT showed minor decrease in uptake over 4 cycles but retained its regeneration efficiency. Desorption capabilities remained relatively constant over the course of the recycling runs, averaging around 80% recovery. Finally, an evaluation of energy integration and consumption for desorption was carried (see Example 5 for calculation details). We estimated about 79.3 kcal/mol Y was used for desorption at 0.8 V for 1 h. The use of lower potentials for oxidation showed lower energy consumption per mol of desorbed Y, however, these had significantly less efficient recovery—demonstrating that further process optimization can help decrease overall electric consumption in the future by optimal selection of operational parameters. In parallel, molecular design of both ligand and redox-active groups can be expected to progressively increase the regeneration efficiency and reversibility.

In summary, we propose a new redox-copolymer as a promising proof-of-concept platform for electrochemically-regenerated ion-exchange for REE ion recovery. Redox-copolymers containing carboxylic acid and ferrocene moieties were synthesized and studied for the effectiveness in recovery of REEs (Y, Nd, Eu, Gd, Dy, and Ce) from aqueous solutions. The copolymer showed increasing REE adsorption capacities with increasing content of MAA, with a 50/50 ratio of ferrocenyl groups to carboxylic acid groups providing optimal balance between uptake and electrochemical regeneration. Adsorption Y(III) on P1-CNT showed an equilibrium capacity of 69.4 mg Y(III)/g polymer at the optimal pH of 6. Electrochemical desorption of the adsorbed REE from the electrodes was achieved by using a positive potential vs Ag/AgCl, to release the bound cation by electrostatic repulsion, with close to full regeneration achievable under certain electrochemical conditions. The adsorption capacity of the recycled P1-CNT electrodes remained relatively constant during four consecutive cycles, confirming the structural stability of redox-active copolymer. In conclusion, our work demonstrates that redox-copolymers can be a tunable functional materials platform for electrochemically-regenerable REE adsorption, thus providing modularity and sustainability to chemical adsorption systems, and future applicability in REE valorization from waste streams, chemical manufacturing separations, and even secondary recovery from various hydrometallurgical streams. We envision this fundamental concept of combining redox-groups with chemical ligands to be expanded to broader ion-exchange processes in the future.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1. Synthesis and Characterization of P(FPMAm-co-MAA)

Materials and instruments. All chemicals were obtained from Sigma Aldrich, VWR, Fisher Scientific or TCI, and used as received. Hydrogen was received from Airgas. MEHQ was removed from methacrylic acid and BzMA by passing it through a column filled with basic aluminium oxide. 1,3-Benzenedisulfonyl Azide (1,3-BDSA) was synthesized according to literature protocols. ¹NMR spectra were recorded on Varian Unity Inova 400 MHz spectrometer or a Varian Unity Inova 500 MHz spectrometer, both equipped with a Nalorac QUAD probe. Electrospray-ionization mass spectrometry (ESI-MS) was performed with a Waters Q-TOF Ultima ESI.

Samples for elemental analysis were weighed with a Mettler Toledo UMT2 and analysed with an Exeter Analytical—Model CE440 CHN Analyser. Scanning Electron Microscopy (SEM) and Energy-dispersive X-ray spectroscopy (EDS) were carried out in the Frederick Seitz Materials Research Laboratory Central Research Facilities, University of Illinois. SEM was taken using a Hitachi S-4700 instrument. Micrograph images were taken at an accelerating voltage of 10 kV. EDS was taken using an attached iXRF EDS Elemental Analysis System with Oxford Instruments (Si(Li) detector). EDS mapping and spectra were taken using an accelerating voltage of 20 kV. The chemical states of iron and presence of REEs on the electrodes were characterized using X-ray photoelectron spectroscopy (XPS; Kratos Axis ULTRA) with monochromatic Al Kα X-ray source (210 W). The XPS results were analysed using CASA XPS software (UIUC license). The spectra were fitted into their components following subtraction of a Shirley background from the region of interest.

Parameters for curve-fitting of Fe2p were determined to known methods.

Dynamic light scattering (DLS) was measured using a Malvern Zetasizer ZS using a 633 nm laser. Gel permeation chromatography was measured using a Tosoh EcoSEC 8320 GPC System. Two Tosoh Alpha-M column were used. 14.5 mM LiBr in DMF was used as the mobile phase. The system was calibrated with a poly(methyl methacrylate) (PMMA) standard for relative molar mass estimations. Differential Scanning Calorimetry (DSC) was measured with a Discovery 2500 Differential Scanning Calorimeter at a heating rate of 10 K/min. Thermogravimetric Analysis (TGA) was measured using a Q50 thermogravimetric analyser from TA instruments.

All electrochemical studies were performed on a VersaSTAT 3 or VersaSTAT 4 potentiostat (Princeton Applied Research) using a BASi cell in a three-electrode configuration with an aqueous Ag/AgCl reference electrode, and a Pt counter electrode. The initial and final concentrations of the REE solutions were determined using ICP-OES (5110 ICP-OES, Agilent Technologies). Samples were measured in 10 replicates.

Synthesis of 2-cyanovinylferrocene. Ferrocene carboxyaldehyde (20 g, 93 mmol) was dissolved in acetonitrile (314 g, 400 mL, 7.66 mol) and stirred under an argon atmosphere. Potassium hydroxide (5.2 g, 93 mmol) was dissolved in water (3 mL) and added to the solution. The solution was subsequently heated to reflux and stirred for 2 hours. After cooling to room temperature, the mixture was filtered, and the acetonitrile was removed under reduced pressure. The residue was dissolved in 100 ml Et₂O and washed with water. The organic phase was dried with MgSO₄ and the solvent removed. The crude product was recrystallized from boiling hexane (60 ml), yielding 2-cyanovinyl ferrocene (21.59 g, 91.07 mmol, 97%) as a red solid. ¹H NMR (400 MHz, CDCl₃, S) 7.29 (d, J=11.8 Hz, 1H, HCCH, trans), 6.98 (d, J=11.6 Hz, 1H, HCCH, cis), 5.44 (d, J=16.2 Hz, 1H, HCCH, trans), 5.19 (d, J=11.6 Hz, 1H, HCCH, cis), 4.86 (t, J=1.9 Hz, 2H, C₅H₄, cis), 4.48 (t, J=2.0, 1.5 Hz, 1H, C₅H₄, cis), 4.47 (s, 4H, C₅H₅, trans) 4.21 (s, 5H, C₅H₅, cis), 4.21 (s, 5H, C₅H₅, trans). HR-ESI m/z: [M]⁺ calcd. for C₁₃H₁₁FeN, 237.0235; found: 237.0237. Anal. calcd for C₁₃H₁₁FeN: C 65.86, H 4.68, N 5.91; found: C 66.79, H 4.63, N 6.03.

Synthesis of 3-ferrocenylpropylamine. A hydrogenation reactor was filled with a solution of cyanovinyl ferrocene (8.0 g, 34 mmol) in ethanol (90 mL) and ammonium hydroxide 30% (30 mL). Raney nickel (7.9 g, 30 wt-% slurry in water, 40 mmol) was added. The reactor was closed, purged with N₂ and pressurized with hydrogen (8 bar). The reactor was stirred at 40° C. for 4 days. The mixture was filtered through a plug of celite to remove the catalyst, and the celite and catalyst were washed with EtOH. The solvents were evaporated, and the residue diluted with 100 ml Et₂O. The organic phase was washed with water and brine, dried with Na₂CO₃ and the solvent evaporated. The procedure yielded 3-Ferrocenyl propylamine (7.03 g, 28.9 mmol, 86%) as a red oil that was used without further purification. ¹H NMR (500 MHz, CDCl₃, δ): 4.11-4.02 (m, 9H, ferrocene), 2.72 (t, J=7.1 Hz, 2H, NH₂—CH₂), 2.37 (t, J=7.8 Hz, 2H, fc-CH₂), 1.66 (p, J=7.3 Hz, 2H), 1.28 (s, 2H, CH₂CH₂CH₂). HR-ESI m/z: [M]⁺ calcd. for C₁₃H₁₇FeN, 243.0705; found, 243.0706. Anal. calcd for C₁₃H₁₇FeN. found: C 64.22, H 7.05, N 5.76).

Synthesis of 3-ferrocenylpropyl methacrylamide (FPMAm). In a dry Schlenkflask with a septum, which was purged with argon, ferrocenyl propylamine (3.00 g, 12.3 mmol) was dissolved in dry dichloromethane (80 mL) and triethylamine (1.37 g, 1.89 mL, 13.6 mmol) was added. The orange solution was subsequently cooled with an ice bath and methacrylic anhydride (2.09 g, 2.02 mL, and 13.6 mmol) was added slowly. After 30 min, the ice bath was removed, and the solution was stirred for another 16 h at room temperature. The reaction solution was washed consecutively with saturated aqueous NaHCO₃ solution, water, and brine. Afterward, the organic phase was dried with MgSO₄ and the solvent was evaporated after filtration. The solvent was removed, yielding the crude product as a brownish oil (4.3 g). The product was purified by flash chromatography (silica column and Hexane/EtOAc gradient). Yielding FPMAm (2.98 g, 9.58 mmol, 78%) as an orange solid. ¹H NMR (500 MHz, CDCl₃, δ): 5.75 (1H, broad, NH), 5.63 (s, 1H, CCH₂), 5.29 (s, 1H, CCH₂), 4.12-4.04 (9H, m, ferrocene), 3.34 (q, J=6.6 Hz, 2H, NHCH₂), 2.40 (t, J=7.6 Hz, 2H, fc-CH₂), 1.93 (s, 3H, CH₃), 1.75 (p, J=7.2 Hz, 2H, CH₂CH₂CH₂). HR-ESI m/z: [M]⁺ calcd. for C₁₇H₂₁FeNO, 311.0967; found, 311.0972. Anal. calcd for C₁₇H₂₁FeNO: C 65.61, H 6.80, N 4.50).

Synthesis of P(FPMAm-co-MAA) (Pn). Exemplary procedure for the synthesis of P1: FPMAm (1.00 g, 3.21 mmol), methacrylic acid (277 mg, 3.21 mmol) and AIBN (10.5 mg, 0.06 mmol) were dissolved in 1,4-Dioxane (4 ml). The mixture was degassed by bubbling with argon for 15 min and heated to 60° C. for 16 h. The polymer was precipitated in diethyl ether (50 ml) and filtered. The polymer was dissolved in 25 ml of THF, precipitated again in diethyl ether and dried under reduced pressure, yielding 1.11 g (87%) P(FPMAm₄₄-co-MAA₅₆) (P1) as an orange solid. GPC: Mₙ=9.5 kg mol⁻¹, M_{w}=31.4 kg mol⁻¹, D=3.29.

Synthesis of P(BzMA-co-MAA) (P5). BzMA (2.00 g, 11.35 mmol), methacrylic acid (977 mg, 11.35 mmol) and AIBN (37.3 mg, 0.23 mmol) were dissolved in 1,4-Dioxane (15 ml). The mixture was degassed by bubbling with argon for 15 min and heated to 60° C. for 16 h. The polymer was precipitated in acetonitrile (50 ml) and filtered. The polymer was dissolved in 25 ml of THF, precipitated again in acetonitrile and dried under reduced pressure, yielding 1.95 g (78%) P(BzMA₅₂-co-MAA₄₈) as a colorless solid.

### Example 2. Synthesis of P(TMA-co-MAA)

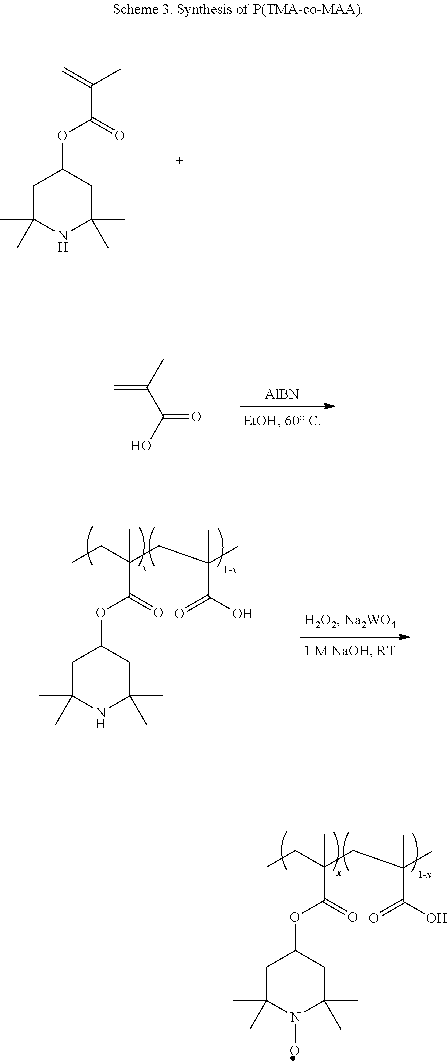

Synthesis of P(TMA-co-MAA). 2,2,6,6-Tetramethylpiperidin-4-yl methacrylate (5.00 g, 22.2 mmol), methacrylic acid (1.91 g, 22.2 mmol) and AIBN (73 mg, 0.44 mmol) were dissolved in Ethanol (15 ml). The mixture was degassed by bubbling with argon for 15 min and heated to 60° C. for 16 h. The precipitated polymer is dissolved in water and purified by dialysis using a regenerated cellulose membrane with a MWCO of 3500 Da. The polymer was precipitated in acetone (400 ml), filtered and dried under reduced pressure, yielding 6.03 g (87%) P(TMPMA-co-MAA).

P(TMPMA-co-MAA (2.00 g) is dissolved in sodium hydroxide solution (1 M, 30 ml) and sodium tungstate dihydrate (159 mg, 0.48 mmol) is added. Hydrogen peroxide (30 wt-%, 4 ml) is added in 2 portions with 24 h stirring in between additions and the mixture is stirred for 48 h. The polymer is purified by dialysis against water and methanol using a regenerated cellulose membrane with a MWCO of 3500 Da. The polymer was precipitated in ethyl acetate (400 ml), collected by centrifugation and dried under reduced pressure, yielding 1.59 g (69%) P(TMA-co-MAA).

### Example 3. Preparation of P(FPMAm-co-MAA)-CNT Electrodes

To fabricate the immobilized ferrocene electrodes, two stocks were prepared: stock A of 12 mg of P(FPMAm-co-MAA) (P1) in 3 mL of deionized (DI) water and 60 μL of 1M NaOH, and stock B with 12 mg of CNT (multiwalled carbon nanotubes) and 1.2 mg of 1,3-BDSA, 1.2 mg of cross-linker in 1.5 mL of Dimethylformamide (DMF). Stock A solution was stirred and heated until the polymer was fully dissolved while stock B was sonicated for 30 min. in ice water. The P1/CNT (1:1) ratio was prepared by mixing stocks A and B and sonicated for 4 h in an ice-bath. Once prepared, Titanium-grade 1 mesh (titanium screen, Fuel Cell Store) cut into rectangles (1 cm×2 cm, 53 m thick), were drop-coated by the solution with the active material, with about 40-50 μL for each drop, and left to dry at 95° C. in an oven between drops. The total coated area was 2 cm². After coating, polymer-coated electrodes were left overnight to ensure all solvent was evaporated. The electrodes were left in oven at 140° C. for 3 h to activate crosslinking. Coated electrodes were then connected to a copper wire with copper tape. These functionalized electrodes will now be referred to as P1-CNT. Electrodes coated with other materials used in this paper were assembled in the same fashion as P1-CNT electrodes with some having variations to the coating solutions.

Preparation of secondary and control adsorbent materials and electrodes: Preparation of P(FPMAm-co-MAA)-CNT Electrodes with varied amounts of crosslinking. Two stocks were prepared: stock A of 12 mg of P(FPMAm-co-MAA) (P1) in 3 mL of Deionized (DI) water and 60 μL of 1M NaOH, and stock B with 12 mg of CNT (multiwalled carbon nanotubes, Sigma-Aldrich) and varied amounts of cross-linker in 1.5 mL of Dimethylformamide (DMF). Added cross-linker percentage to mass: 0% cross-linker 0 mg cross-linker, 5% cross-linker 0.6 mg cross-linker, 10% cross-linker 1.2 mg cross-linker, 20% cross-linker 2.4 mg cross-linker. Stock A solution was stirred and heated until polymer was fully dissolved while stock B was sonicated for 30 min. in icy water. The P1/CNT (1:1) ratio was prepared by mixing stocks A and B and sonicated for 4 h in an ice-bath. Once prepared, Titanium-grade 1 mesh (titanium screen, Fuel Cell Store) cut into rectangles (1 cm×2 cm, 53 m thick), were drop-coated by the solution with the active material, with about 40-50 μL for each drop, and left to dry at 95° C. in oven between drops. Coated area was about 1 cm×1 cm surface area on each front and back side. After coating, polymer-coated electrodes left overnight to ensure all solvent is evaporated. Then electrodes left in oven at 140° C. for 3 h to activate crosslinking. Coated electrodes were then connected to a copper wire with copper tape. The same methodology was used for P(FPMAm₇₀-co-MAA₃₀)-CNT Electrodes, P(FPMAm₂₅-co-MAA₇₅)-CNT Electrodes, and Preparation of P(BzMA₅₂-MAA₄₈)-CNT Electrodes.

Preparation of CNT Electrodes. Stock 12 mg of CNT (multiwalled carbon nanotubes, Sigma-Aldrich) dispersed in 3 mL of chloroform (4 mg of CNT/1 mL chloroform). Stock solution was sonicated in icy water to allow for CNT dispersion. Once prepared, Titanium-grade 1 mesh (titanium screen, Fuel Cell Store) cut into rectangles (1 cm×2 cm, 53 m thick), were dip-coated by the solution with the CNT material. Coated area was about 1 cm×1 cm surface area on each front and back side. Coated electrodes were then connected to a copper wire with copper tape.

Preparation of FPMAm-CNT Electrodes. Electrode preparation was adapted from previously reported procedures (Chemistry of Materials, 2017, 29, 5702). Two stocks were prepared: stock A of 40 mg of FPMAm (P4) and 20 mg of CNT in 10 mL of anhydrous chloroform, and stock B with 20 mg of CNT. The two stock solutions were sonicated for 2 h in icy water to optimize dispersion level. The P4/CNT (1:1) ratio was prepared by mixing stocks A and B in a 1:1 ratio and sonicated for another 3 h in an ice-bath. Once prepared, Titanium-grade 1 mesh (titanium screen, Fuel Cell Store) cut into rectangles (1 cm×2 cm, 53 m thick), were dip-coated by the solution with the CNT material. Coated area was about 1 cm×1 cm surface area on each front and back side. Coated electrodes were then connected to a copper wire with copper tape.

Stability of P(FPMAm-co-MAA)-CNT electrodes relating to amount of used cross-linker. Cyclic voltammetry (CV) characterization was carried out to investigate the stability, with varying amounts of added cross-linker, of P1-CNT/Ti. Electrodes were placed in 10 mL of 100 mM NaClO₄ aqueous solution with CVs conducted in potential range of −1.1 to 1.1 V for all cycles. Over 100 cycles were conducted for each electrode (5 cycles @ 0.1 V/s→100 cycles @ 0.05 V/s→5 cycles @ 0.01 V/s→11 cycles @ 0.05 V/s). 100 cycles of the CV ran at a scan rate of 0.05 V/s are shown in FIG. 9.

### Example 4. Adsorption Experiments

Equilibrium adsorption tests. Batch adsorption experiments were mostly carried out with yttrium(III) to determine adsorption parameters; with Y(III) being used as the model for REE ions in this system for most of the proof-of concept. We also evaluate our electrodes for Neodymium (Nd), europium (Eu), gadolinium (Gd), dysprosium (Dy), and cerium (Ce) to demonstrate generality in the concept. Stock solutions were prepared containing 1 mM YCl₃ and 20 mM NaCl in water (NdCl₃, EuCl₃, GdCl₃, DyCl₃, or CeCl₃ replacing YCl₃ when applicable), with the REE as the minority ion in twenty-fold competing cation to mimic brackish industrial and mining wastewater conditions. All adsorption tests were performed with Titanium (Ti) coated electrode in 10 mL of stock solution and stirred at 300 rpm at room temperature. Experiments were run for 1 h unless otherwise stated. The initial and final concentrations of the REE solutions were determined using ICP-OES (5110 ICP-OES, Agilent Technologies). Samples were run through the ICP in 10 replicates, with each experiment solution measured in triplicates and each experiment repeated at least twice. The uptake values are reported as the adsorption capacity normalized by the mass of the total coating (polymer+CNT+cross-linker per electrode, unless otherwise stated). Adsorption capacity was determined using eq 2:

$$q = \frac{( {C}_{O} - C ) \times V}{m} \qquad ( 2 )$$

Here q is the adsorption capacity (mg/g), C₀ and C is the initial and final REE ion concentration (mg/L), V is the volume of the solution (L), and m is the mass of the electrode coating (g).

Adsorption data fitting by kinetic models. To investigate the adsorption process of Y(III) on P1-CNT/Ti, pseudo-first-order (PFO) and pseudo-second-order (PSO) kinetic models were used to fit the experimental kinetics data. The linear forms of PFO (eq 3) and PSO (eq 4) models are expressed as follows:

$$log ( {q}_{e} - {q}_{t} ) = log {q}_{e} - \frac{{k}_{1}}{2.303} t ; \qquad ( 3 )$$

$$\frac{t}{{q}_{t}} = \frac{1}{{k}_{2} {q}_{e}^{2}} + \frac{t}{{q}_{e}} . \qquad ( 4 )$$

Here, qₑ and qₜ (mg/g) are the amount of Y(III) adsorbed on the adsorbent at equilibrium and at time t (min), respectively. k₁(min⁻¹) and k₂ (g mg⁻¹ min⁻¹) are the PFO and PSO rate constants, respectively. The slope and intercept of log(gₑ-qₜ) vs t are used to determine the rate constant for PFO with a straight line suggesting the applicability of the PFO kinetic model to fit the experimental data. The slope and intercept of t/qₜ vs t are used to determine the rate constant for PSO with a linear relationship suggesting if PSO kinetics is. FIG. 12 shows the linear fit plots for both kinetic models and the final fits to the experimental data. The parameters of the PFO and PSO models and the correlation coefficients (R²) estimated using the two models are given in Table 3. FIG. 13 shows the kinetic data and modelling using PFO and PSO for the adsorption Y(III) on P1-CNT/Ti.

Adsorption data fitting by isotherm models. The Langmuir isotherm model, which assumes that adsorption takes place as a monolayer over the surface of the adsorbent, is given by eq 5:

$$\frac{{C}_{e}}{{q}_{e}} = \frac{1}{{K}_{L} {q}_{m ax}} + \frac{{C}_{e}}{{q}_{ma x}} . \qquad ( 5 )$$

Cₑ (mg/L) represents the equilibrium concentration of Y(III) in the solution, qₑ (mg/g) is the amount of Y(III) adsorbed on the adsorbent, qₘₐₓ (mg/g) is the maximum adsorption capacity of Y(III), and K_{L} (L/mg) is the Langmuir constant, which is related to the affinity of the binding sites. The experimental data was fitted to the Langmuir model through plotting Cₑ/qₑ versus Cₑ. The fitted line is used to obtain qₘₐₓ and K_{L} from the slope and intercept (FIG. 14a).

The Freundlich mode describes the adsorption processes that occur on heterogonous surfaces, and is given by:

$$ln {q}_{e} = ln {K}_{F} + \frac{1}{n} ln {C}_{e} . \qquad ( 6 )$$

K_{F} (mg/g) is a Freundlich equation constant that indicates adsorption capacity and n is the Freundlich constant indicating adsorption intensity. K_{F} and n are determined from the slope and intercept of the linear plot of ln(gₑ) versus ln(Cₑ) (FIG. 14b).

The parameters of the Langmuir and Freundlich models and the correlation coefficients (R²) estimated using the two models are given in Table 4. FIG. 15 shows the adsorption isotherm and modelling using Langmuir and Freundlich for the adsorption Y(III) on P1-CNT/Ti.

P(FPMAm-co-MAA) adsorbed REE mol to adsorption site ratio calculations. The number of adsorbed REE moles and moles of adsorption sites (COOH) on the polymer are calculated and compared to give an idea of adsorbent uptake efficiency and the relationship of the adsorption sites the adsorbed RE ions.
m=mass of total electrode coating (mg)
mₚ=mass of polymer on electrode (mg)
m_{MAA}=mass of provided by MAA in polymer on electrode (mg)
MW_{COOH}=molecular weight of MAA monomer (g/mol)
MW_{COOH}=86.09 (g/mol)
MW_{FC}=molecular weight of FPMAm monomer (g/mol)
MW_{FC}=311.2 (g/mol)
MW_{REE}=molecular weight of REE (g/mol)
C₀=Initial RE ion concentration in solution (mg/L)
C=Final RE ion concentration in solution (mg/L)
V=Volume of solution (L)
FPMA_{mol%}=mol % of FPMA for given copolymer (mol %)
MAA_{mol%}=mol % of MAA f or given copolymer (mol %)
n_{COOH}=moles of MAA (adsorption sites) on given electrode (mmol)
n_{REE}=moles of REE adsorbed onto given electrode (mmol)

Note: Electrode polymer mass (mₚ) is estimated to equal half of the total electrode coating

$$( i . e . {m}_{p} = \frac{m}{2} )$$

since the electrode coating is made with a 1:1 polymer to CNT mix.

Moles of adsorption sites on given adsorbent is calculated as follows:

$${m}_{M A A} = {m}_{p} \times \frac{M A {A}_{mo l \%} \times M {W}_{C O O H}}{( F P M {A}_{m ol \%} \times M {W}_{F c} ) + ( M A {A}_{mo l \%} \times M {W}_{C O O H} )}$$

$${n}_{C O O H} = \frac{{m}_{M A A}}{M {W}_{C O O H}}$$

Moles of REE ions adsorbed is calculated as follows:

$${n}_{R E E} = \frac{{C}_{O} - C}{M {W}_{R E E}} \times V$$

Effects of Solution pH on REE Adsorption. The effect pH on adsorption capacity was investigating by adjusting a solution of 1 mM YCl₃ and 20 mM NaCl to desired pH values using either dilute HCl or NaOH solution.

Adsorption kinetics and equilibrium isotherm. Kinetics were measured with the P1-CNT electrode placed in Y(III) stock solution (10 mL of 1 mM YCl₃ and 20 mM NaCl, pH=6). Equilibrium isotherm was measured at different initial concentrations, (10 mL of 0.1-3.0 mM YCl₃ and 20 mM NaCl, pH=6), stirred at 300 rpm at room temperature for 1 h.

Adsorption selectivity. REE stocks used in single REE adsorption tests contained 20 mM NaCl. XPS spectra was used to compare uptake of REE ions and Na ions when using P1-CNT electrodes. Electrodes examined were in 10 mL of aqueous solution containing 1 mM YCl₃ and 20 mM NaCl for 1 h. Selectivity between selected REE ions was also tested by assaying each sample for all the REE before and after adsorption. 10 mL of a solution containing a mixture of Y(III) and Ce(III), and 10 mL of a solution containing a mixture of Y(III) and Dy(III), at a concentration of 1 mM each were tested.

### Example 5. Electrochemically Mediated Regeneration

For desorption tests, 10 mL of solution with background electrolyte concentration of 20 mM NaCl was used. Chronoamperometry was used for all desorption tests in this work. ICP-OES was used to determine the amount of REE ions desorbed into solution. The electrode regeneration experiments were carried out similarly with Y(III) as the model REE ion. After electrochemical desorption, the P1-CNT was reduced to neutralize the positive charge and reuse the electrode for cation adsorption. Chronopotentiometry was used for electrode reduction steps, with applied current of −0.025 mA under nitrogen purge (procedure optimized after trial and error). The electrodes could then be subsequently used for further adsorption/desorption cycles.

P(FPMAm-co-MAA)-CNT Electrode cycling: Reduction during uptake stage. Testing cycling if reduction occurred while uptake steps after the first cycle (FIG. 20).

Sorption solution: 10 mL of 1 mM YCl₃/20 mM NaCl; Sorption solution: 10 mL of 20 mM NaCl.

Sorption conditions:
Cycle 1: 1 h open circuit
Cycle 2-3: 1 h chronopotentiometry −0.025 mA

Desorption conditions: Cycle 1-3: 1 h chronoamperometry 0.8 V vs Ag/AgCl

### P(FPMAm-Co-MAA)-CNT Electrode Desorption Energy Consumption.

$$Energy Consumption ( J ) = \int ( Potential ( V ) \times Current ( A ) )$$

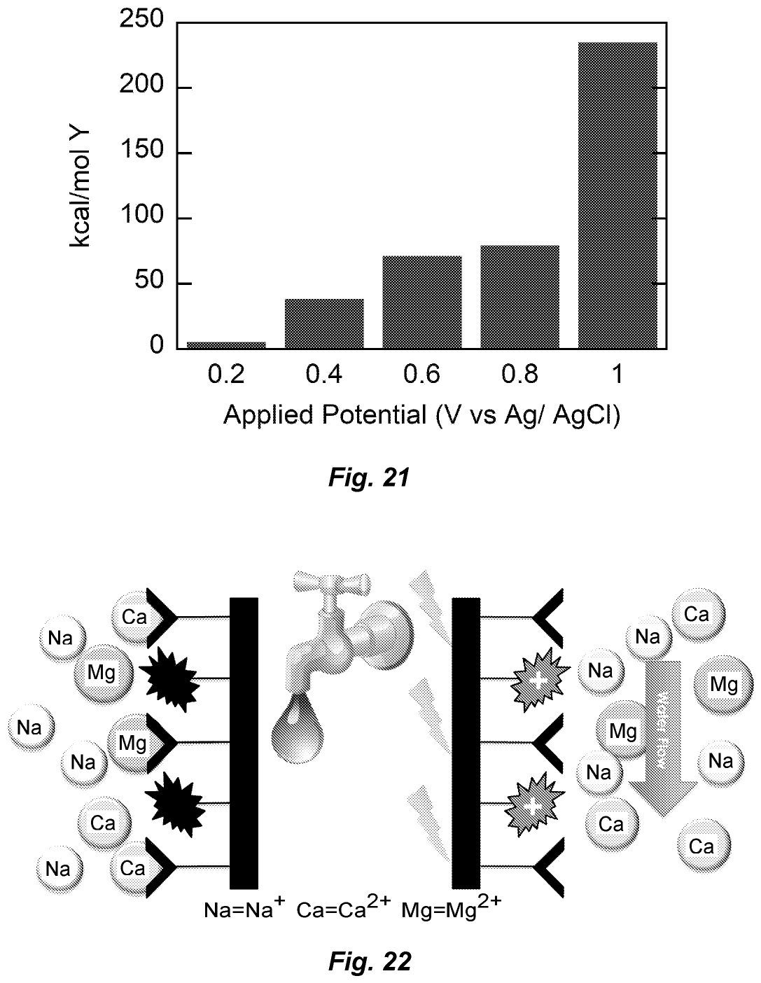

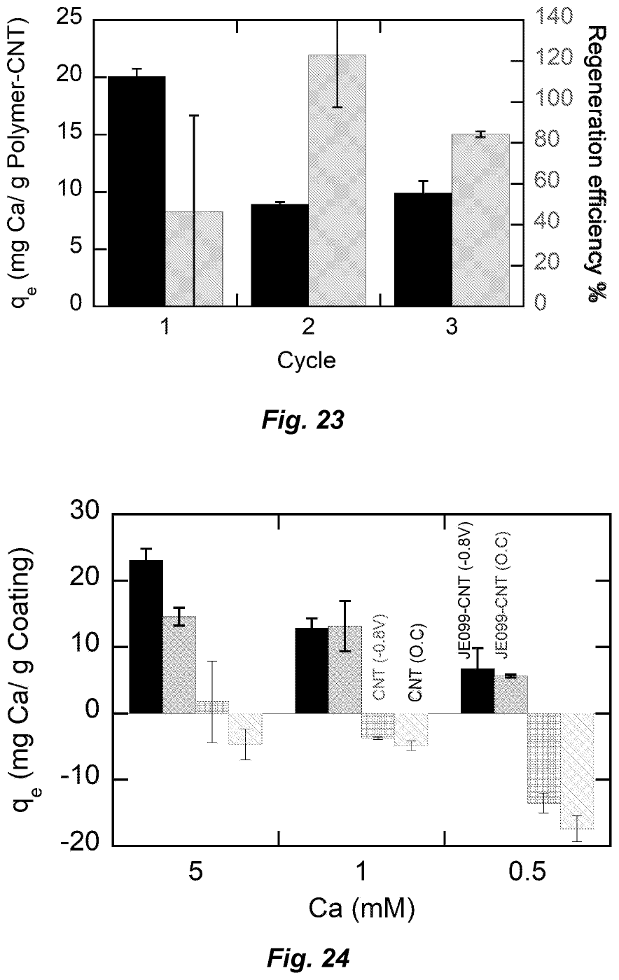

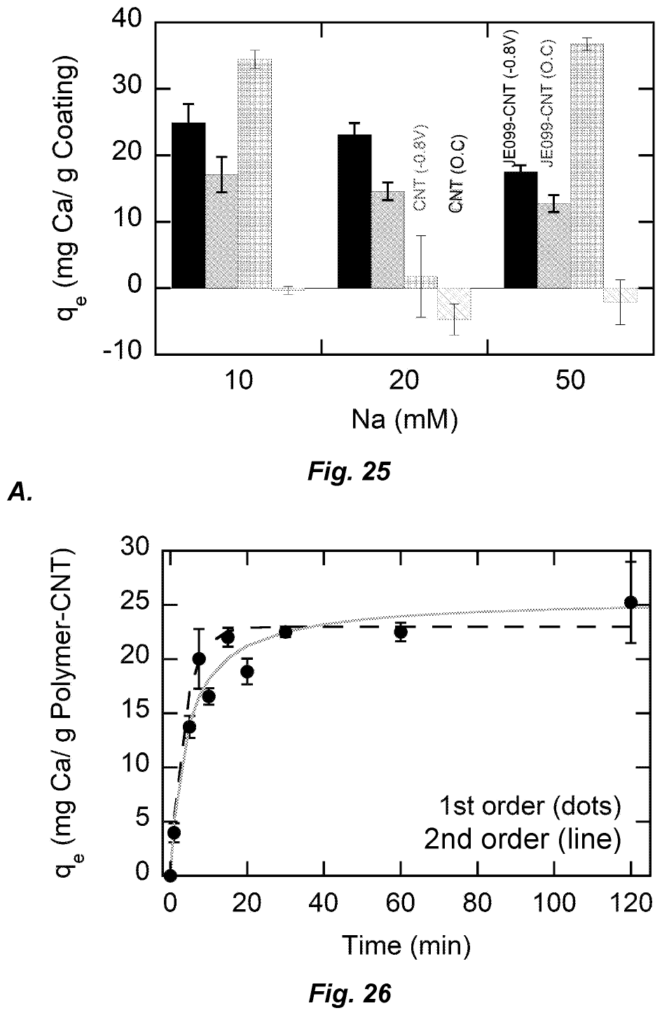

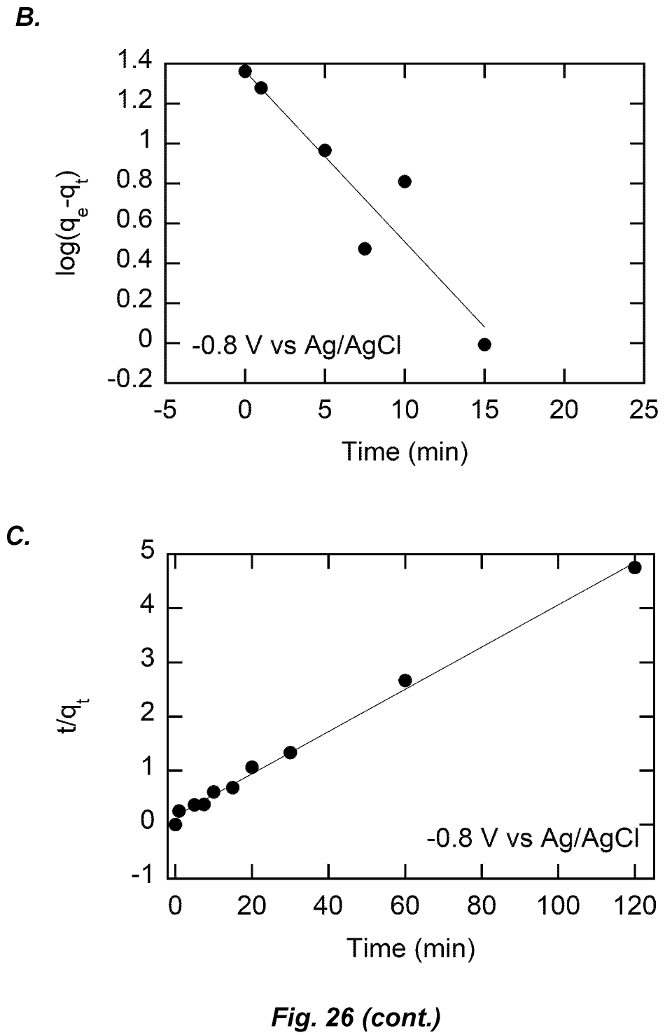

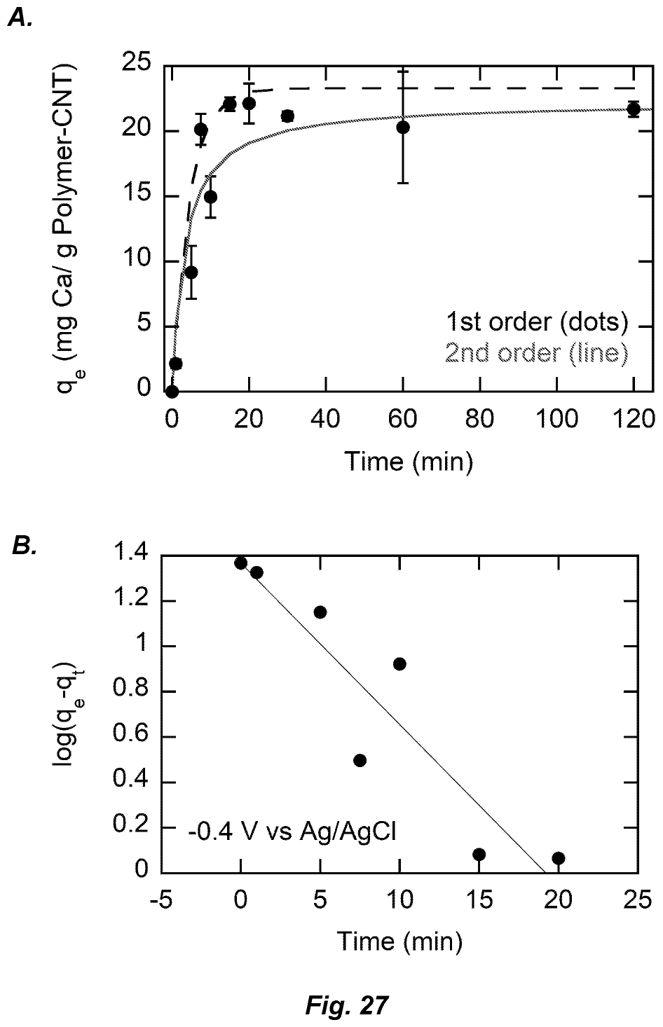

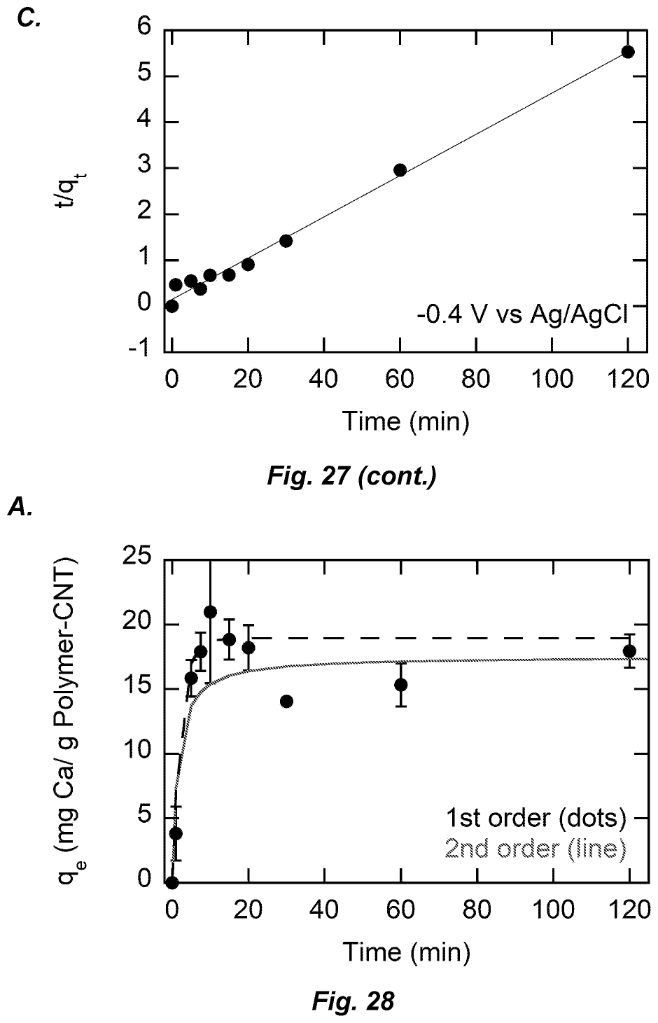

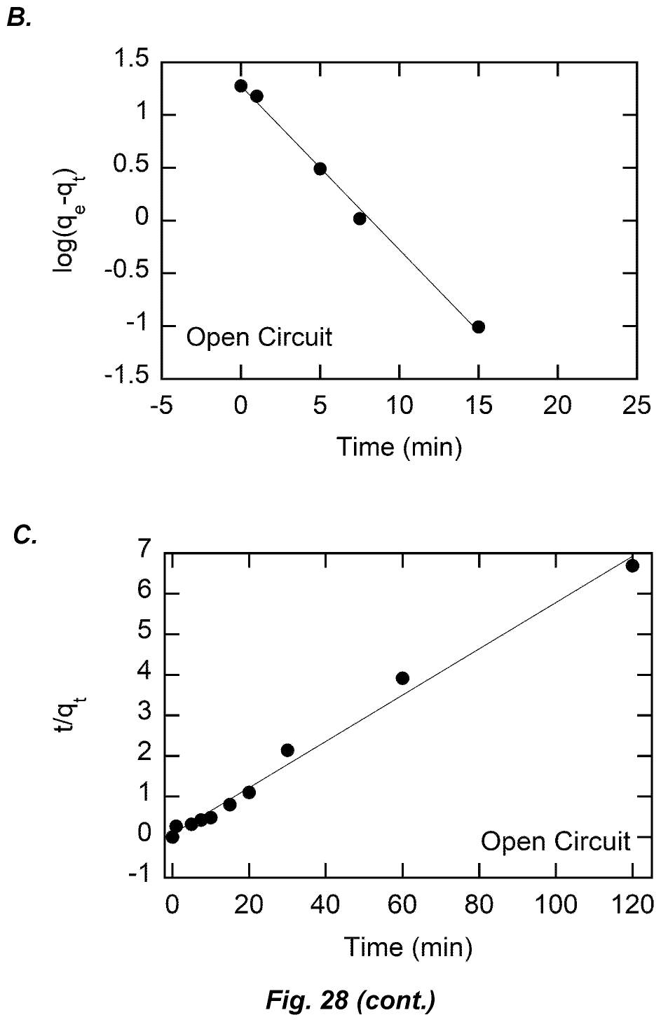

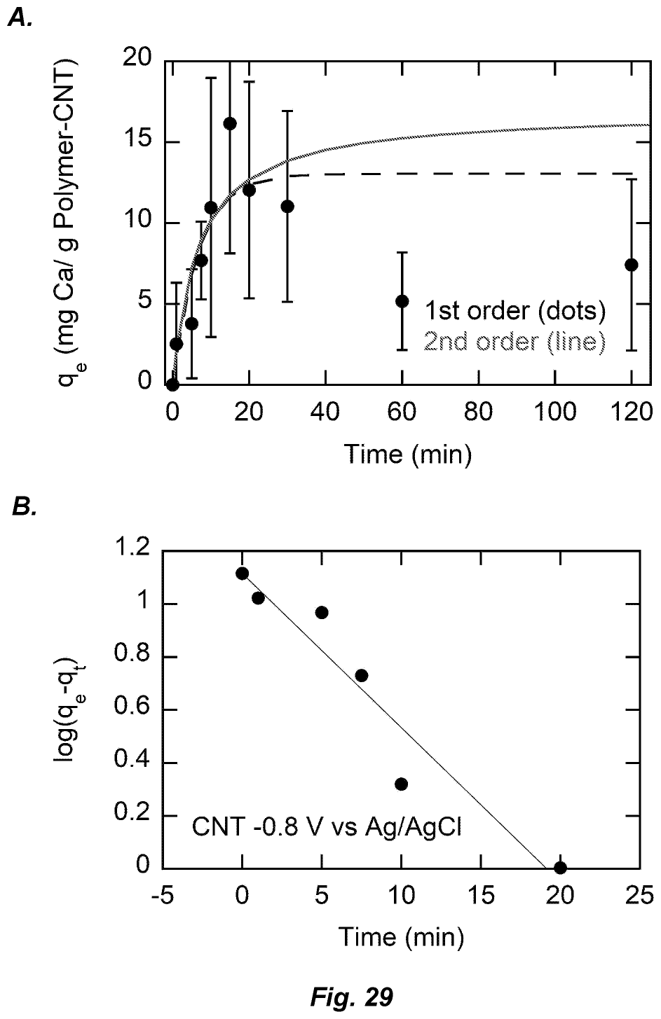

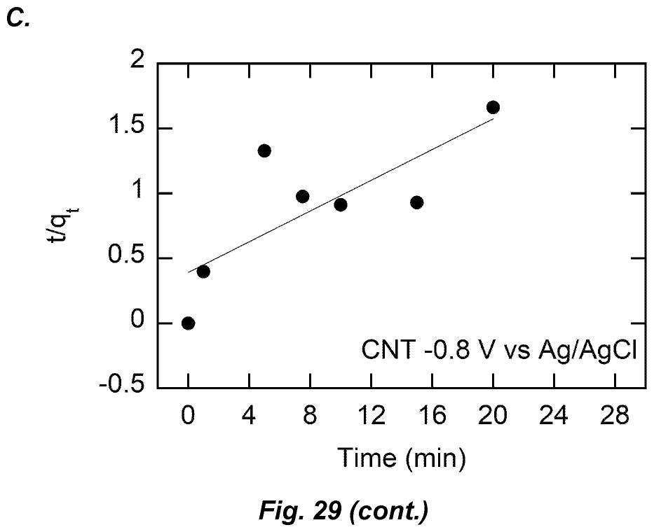

Energy consumption per desorbed moles of Y for P1-CNT Electrode Desorption first cycle (1 h at 0.8 V vs Ag/AgCl): 331.62 kJ/mol Y (79.2 kcal/mol Y) (FIG. 21).

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

1. A redox-active copolymer comprising:
a) an organometallic monomer comprising a redox group wherein the redox group has a redox-active transition metal or an organic redox-moiety; and
b) an organic monomer comprising a covalently bound acid group wherein the acidic group is metal ion binding moiety;
wherein the organometallic monomer and organic monomer form the redox-active copolymer.

2. The copolymer of claim 1 wherein the transition metal is iron, cobalt, ruthenium, or nickel.

3. The copolymer of claim 1 wherein the redox group comprises a metallocene or an aminoxyl group.

4. The copolymer of claim 1 wherein the redox group comprises ferrocene or ferrocenium.

5. The copolymer of claim 1 wherein the organometallic monomer comprises a ferrocenylalkyl acrylamide.

6. (canceled)

7. The copolymer of claim 1 wherein the organic monomer comprises an acrylic acid.

8. The copolymer of claim 1 wherein the organometallic monomer (A) and organic monomer (B) have an A:B molar ratio of about 20:80 to about 80:20.

9. (canceled)

10. The copolymer of claim 1 wherein the copolymer comprises a crosslinker.

11. The copolymer of claim 10 wherein the copolymer comprises 0.05 wt. % to about 0.25 wt. % of the crosslinker.

12. The copolymer of claim 10 wherein the crosslinker comprises a 1,3-benzenedisulfonyl moiety.

13. The copolymer of claim 1 wherein the copolymer is represented by Formula I or II: 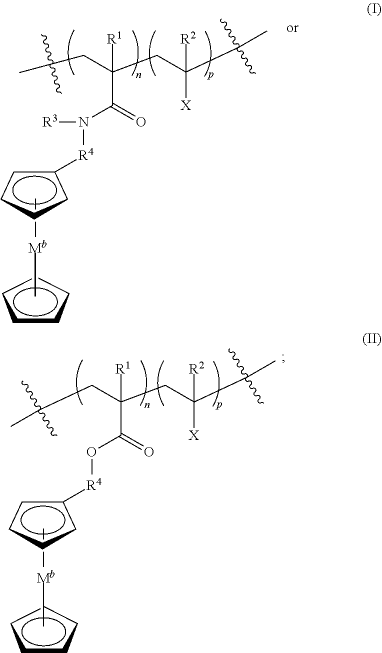
wherein
M is a transition metal;
b is the oxidation state of M wherein the oxidation state is 0-6;
R¹ and R² are each independently —(C₁-C₆)alkyl, —(C₁-C₆)cycloalkyl, or H;
R³ is H, —(C₁-C₆)alkyl, or —(C₁-C₆)cycloalkyl;
R⁴ is —(C₁-C₁₀)alkylene-;
X is C(═O)OH, P(═O)(OH)₂, or S(═O)₂OH;
n is 1-10,000; and
p is 1-10,000;
wherein the metallocene moiety is optionally further substituted.

14. The copolymer of claim 13 wherein R¹ and R² are CH₃, R³ is H, R⁴ is —(CH₂)₃—, and M is Fe.

15. A redox-active copolymer comprising:
a) a first monomer comprising a redox group, wherein the redox-group comprises a redox-active transition metal or an organic redox-moiety comprising an aminoxyl group, and
b) a second monomer comprising a chemical binding group that can bind a rare earth element (REE) transition metal ion or an alkaline earth metal ion wherein the chemical binding group is an organic acid, a chelator, or an organic ligand;
wherein the first monomer and second monomer form the redox-active copolymer.

16. The copolymer of claim 1 wherein the copolymer is: 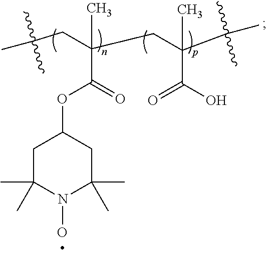
wherein n is 1-10,000; and p is 1-10,000.

17. An electrode comprising a composition of the copolymer of claim 1 and a carbon nanotube wherein the composition is coated on a conductor of the electrode.

18. (canceled)

19. (canceled)

20. A method for separating a rare earth element from a mixture comprising:
a) adsorbing a metal ion of a rare earth element on the electrode of claim 17 under suitable adsorption conditions to separate the metal ion from the mixture, wherein the redox group of the electrode has a net charge of zero; and
b) electrochemically desorbing the metal ion from the electrode into an electrolyte under suitable desorption conditions, wherein the redox group of the electrode has been oxidized to a net charge of at least +1.

21. The method of claim 20 wherein the metal ion is in a mixture comprising other metal ions, wherein the other metal ions are not rare earth metal ions, and the metal ion is selectively adsorbed over the other metal ions.

22. (canceled)

23. The method of claim 20 wherein the rare earth element is cerium (Ce), gadolinium (Gd), neodymium (Nd), europium (Eu), terbium (Tb), dysprosium (Dy), and yttrium (Y).

24. (canceled)

25. The method of claim 20 wherein the suitable desorption conditions comprise applying a potential to the electrode of about +0.4 V to about +1 V versus an Ag/AgCl reference electrode.

26. The method of claim 20 wherein the method further comprises:
c) reducing the oxidized redox group of the electrode under suitable reduction conditions from the at least +1 net charge to a net charge of zero.

27.-33. (canceled)
